(19) United States
(12) Patent Application Publication
(10) Pub. No.: US 2013/0003856 A1
(43) Pub. Date: Jan. 3, 2013

(54) MODE-DEPENDENT TRANSFORMS FOR RESIDUAL CODING WITH LOW LATENCY

(75) Inventors: Ankur SAXENA, Dallas, TX (US); Felix Carlos FERNANDES, Plano, TX (US)

(73) Assignee: SAMSUNG ELECTRONICS CO. LTD., Suwon-si (KR)

(21) Appl. No.: 13/534,684

(22) Filed: Jun. 27, 2012

Related U.S. Application Data
(60) Provisional application No. 61/504,136, filed on Jul. 1, 2011.
(60) Provisional application No. 61/538,656, filed on Sep. 23, 2011.
(60) Provisional application No. 61/548,656, filed on Oct. 18, 2011.
(60) Provisional application No. 61/561,769, filed on Nov. 18, 2011.

(51) Int. Cl. H04N 7/30

(52) U.S. Cl. 375/240.18; 375/E07.226

(57) ABSTRACT

An apparatus and method for processing video data are provided. The method includes determining a primary transform C_{N} for application to residual data at the encoder, determining a secondary transform Tr_{K} for application to the residual data, applying the primary transform C_{N} to the residual data, and selectively applying the secondary transform Tr_{K} to the residual data, wherein N denotes the length size of the input vector on which the primary transform C_{N} is applied, and K denotes the length of the first few coefficients of the primary transform output on which the secondary transform Tr_{K} is applied. Similar inverse operations are performed at the decoder, viz., selectively applying an inverse secondary transform inv(Tr_{K}) at the decoder for the input residual data, followed by application of the inverse primary transform inv(C_{N}).

### CROSS-REFERENCE TO RELATED APPLICATIONS

This application claims the benefit under 35 U.S.C. §119(e) of a U.S. Provisional application filed on Jul. 1, 2011 in the U.S. Patent and Trademark Office and assigned Ser. No. 61/504,136, of a U.S. Provisional application filed on Sep. 23, 2011 in the U.S. Patent and Trademark Office and assigned Ser. No. 61/538,656, of a U.S. Provisional application filed on Oct. 18, 2011 in the U.S. Patent and Trademark Office and assigned Ser. No. 61/548,656, and of a U.S. Provisional application filed on Nov. 18, 2011 in the U.S. Patent and Trademark Office and assigned Ser. No. 61/561,769, the entire disclosure of each of which is hereby incorporated by reference.

### BACKGROUND OF THE INVENTION

1. Field of the Invention

The present invention relates to an apparatus and method for video coding. More particularly, the present invention relates to an apparatus and method for determining transforms for residual coding.

2. Description of the Related Art

In the ongoing standardization of High Efficiency Video Coding (HEVC), alternative transforms to the standard Discrete Cosine Transform (DCT) are being proposed for intra-prediction residuals. These transforms can broadly be categorized as either training-based transforms or model-based transforms. Prominent amongst the training based transforms is the Mode-Dependent Directional Transforms (MDDT). In MDDT, a large training set of error residuals is collected for each intra-prediction mode and then the optimal transform matrix is computed using the residual training set. However, MDDT requires a large number of transform matrices (e.g., up to 18 at block sizes of N=4 and 8). The model-based transform assumes that the video signal is modeled as a first order Gauss-Markov process and then the optimal transform is derived analytically. These model based transforms require only 2 transform matrices at a block size.

A Discrete Sine Transform (DST) Type-7, with frequency and phase components different from the conventional DCT, has been derived for the first-order Gauss-Markov model when the boundary information is available in one direction, as in intra prediction in the H.264/Advanced Video Coding (AVC) standard. It has also been shown that if prediction is not performed along a particular direction, then DCT performs close to the optimal Karhunen-Loeve Transform (KLT). The idea was applied to the vertical and horizontal modes in intra-prediction in H.264/AVC and a combination of the proposed DST Type 7 and conventional DCT has been used adaptively. The combination of DST and DCT has also been applied to other prediction modes in H.264/AVC and it has been shown that there is only a minor loss in performance in comparison to MDDT. For example, DST has been applied for various modes in Unified Intra Directional Prediction for HEVC. In some cases however, an additional set of quantization and inverse quantization tables were necessary. In other cases, there were 2 different implementations for DCT. In still other cases, no additional set of quantization or inverse quantization tables were used and only a single implementation of DCT was used but there were no fast implementations for the DST-Type 7 transform matrices and full matrix multiplication was used to perform the DST operations for the DST and inverse DST matrices.

To overcome the shortcoming of full matrix multiplication for appropriately scaled DST Type 7 (i.e., in order to retain the same set of quantization and inverse quantization matrices), a fast DST implementation for the 4×4 DST was presented in which the forward DST took 9 multiplications while the inverse DST used only 8 multiplications.

However, the 8×8 DST transform does not provide significant gains for all the intra prediction modes for Unified Intra Directional Prediction for HEVC. The primary reason is that for oblique modes (i.e., modes other than vertical and horizontal), DST may not be the optimal transform at block sizes larger than 4×4. Hence, there is a need to devise optimal transforms for intra prediction residues for block sizes of 8×8 and higher.

Further, a 4-point secondary transform has been designed by smoothing a correlation matrix for the intra prediction residues (with ρ=1) at size 8, and taking only the top 4×4 portion of the 8×8 correlation matrix. The derived 4-point secondary transform was then applied for blocks of sizes 8×8, 16×16 and 32×32. However, this transform was not optimal for block-sizes of 16×16 and 32×32 since it was only designed for blocks of size 8×8 and re-used at the other block sizes. Hence, there is a need to derive optimal transforms that work well for all the block sizes (e.g., 8×8, 16×16, 32×32) and possibly higher.

Also, in general, a 2-d secondary transform is applied once the 2-d primary transform (e.g., DCT) finishes. This implies that the overhead (in terms of latency) would be approximately equal to the ratio of cycles for the secondary transform to the cycles for the primary transform. But for a practical implementation, the latency of secondary transform should be low. Hence, there is a need for different low-latency architectures for secondary transform after the primary transform.

### SUMMARY OF THE INVENTION

Aspects of the present invention are to address at least the above-mentioned problems and/or disadvantages and to provide at least the advantages described below.

In accordance with an aspect of the present invention, a method for encoding video data is provided. The method includes determining a primary transform C_{N} for application to residual data, determining a secondary transform Tr_{K} for application to the residual data, applying the primary transform C_{N} to the residual data, and selectively applying the secondary transform Tr_{K} to the residual data, wherein N denotes the length size of the input vector on which the primary transform C_{N} is applied, and K denotes the length of the first few coefficients of the primary transform output on which the secondary transform Tr_{K} is applied.

In accordance with another aspect of the present invention, an apparatus for encoding video data is provided. The apparatus includes a primary transform unit for determining a primary transform C_{N} for application to residual data and for applying the primary transform C_{N} to the residual data, and a secondary transform unit for determining a secondary transform Tr_{K} for application to the residual data, and for selectively applying the secondary transform Tr_{K} to the residual data, wherein N denotes the length size of the input vector on which the primary transform C_{N} is applied, and K denotes the length of the first few coefficients of the primary transform output on which the secondary transform Tr_{K} is applied.

In accordance with yet another aspect of the present invention, a method for decoding video data is provided. The method includes determining an inverse secondary transform inv(Tr_{K}) for application to residual data, determining an inverse primary transform inv(C_{N}) for application to the residual data or an output of an inverse secondary transform unit, selectively applying the inverse secondary transform inv(Tr_{K}) to the residual data, and applying the inverse primary transform inv(C_{N}) to the residual data, wherein N denotes the length size of the input residual vector on which the inverse primary transform inv(C_{N}) is applied, and K denotes the length of the first few coefficients of the input residual data on which the inverse secondary transform inv(Tr_{K}) is applied.

In accordance with still another aspect of the present invention, an apparatus for decoding video data is provided. The apparatus includes an inverse secondary transform unit for determining an inverse secondary transform inv(Tr_{K}) for application to residual data, and for selectively applying the inverse secondary transform inv(Tr_{K}) to the residual data, and an inverse primary transform unit for determining an inverse primary transform inv(C_{N}) for application to the residual data or an output of the inverse secondary transform unit and for applying the inverse primary transform inv(C_{N}) to the residual data or the output of the inverse secondary transform unit, wherein N denotes the length size of the input residual vector on which the inverse primary transform inv(C_{N}) is applied, and K denotes the length of the first few coefficients of the input residual data on which the inverse secondary transform inv(Tr_{K}) is applied.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 illustrates an N×N block of Discrete Cosine Transform (DCT) coefficients according to a related art;

FIG. 2 is a block diagram illustrating application of an additional transform as an alternate primary transform according to the related art;

FIG. 3 is a block diagram illustrating application of an additional transform as a secondary transform according to an exemplary embodiment of the present invention;

FIG. 4 illustrates a process for deriving a K×K secondary transform from an N×N correlation matrix R_{N} according to an exemplary embodiment of the present invention;

FIG. 5 illustrates decoder operations for mode-dependent secondary transforms according to an exemplary embodiment of the present invention;

FIGS. 6A-6C illustrate different categories of prediction modes according to exemplary embodiments of the present invention.

FIG. 7 illustrates a split Prediction Unit (PU) and an error distribution within the top-left Transform Unit (TU) according to the related art;

FIG. 8 illustrates the partitioning of a prediction unit of size 2N×2N into transform units of size N×N according to an exemplary embodiment of the present invention;

FIG. 9 illustrates a block diagram of a video encoder according to an exemplary embodiment of the present invention; and

FIG. 10 is a block diagram of a video decoder according to an exemplary embodiment of the present invention.

Throughout the drawings, it should be noted that like reference numbers are used to depict the same or similar elements, features, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions are omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention are provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

Exemplary embodiments of the present invention include several innovative concepts not previously disclosed. First, an exemplary apparatus and method for determining a low complexity secondary transform for residual coding that re-uses a primary alternate transform to improve compression efficiency is provided. Second, an exemplary apparatus and method is provided for deriving secondary transforms from a primary alternate transform when a correlation coefficient in a covariance matrix of intra residues in a Gauss-Markov model is varied. Third, an exemplary apparatus and method for reducing the latency of the secondary transform are also presented. Finally, an exemplary apparatus and method for improving compression efficiency by using a 4×4 Discrete Sine Transform for Chroma is provided. Each of the novel innovations will described in turn below.

1. Low Complexity Secondary Transform from Primary Alternate Transform

In order to improve compression efficiency, alternate primary transforms, other than the conventional Discrete Cosine Transform (DCT), can be applied at block sizes of 8×8, 16×16 and 32×32. However, these alternate primary transforms will have the same size as the block size. In general, when these alternate primary transforms are used with higher block sizes, such as 32×32, they may only have marginal gains that do not justify the cost of supporting an additional 32×32 transform.

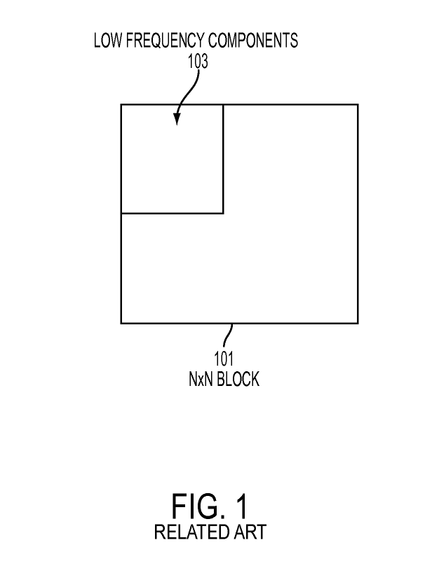

FIG. 1 illustrates an N×N block of DCT coefficients according to the related art.

Referring to FIG. 1, an N×N block 101 of DCT coefficients includes a plurality of coefficients (not shown) obtained as a result of a DCT operation. Most of the energy in the DCT coefficients is concentrated in the low frequency coefficients 103 that are located at the top left of the N×N block 101. Therefore, it should be adequate to perform operations on only a subset of the top-left coefficients 103 (e.g., a 4×4 or 8×8 block of coefficients) of the DCT output. These operations can be performed by simply using a secondary transform of size 4×4 or 8×8. Furthermore, the same secondary transform derived for a smaller block size (e.g., 8×8) can be applied at higher block sizes (e.g., 16×16 or 32×32). This re-utilization at higher block sizes is an important advantage of a secondary transform.

Next, an example is provided to illustrate that a primary alternate transform and a secondary transform are mathematically equivalent.

### 1.1 Relating Alternate Primary Transform and Secondary Transform

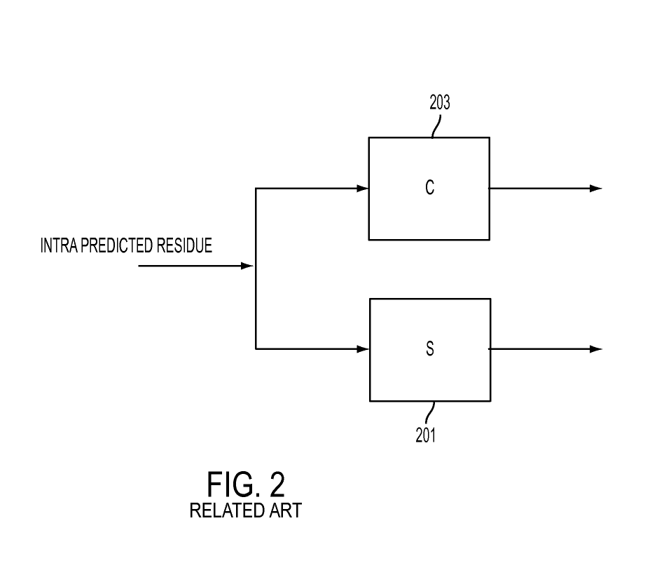

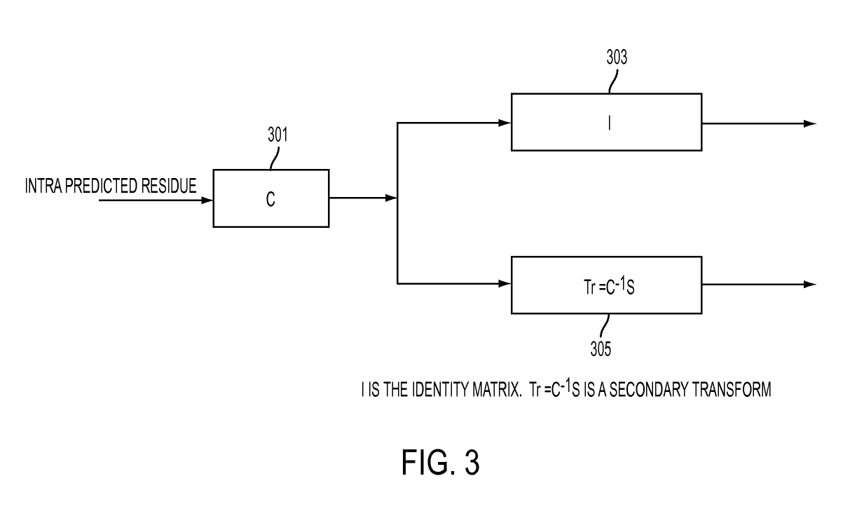

FIG. 2 is a block diagram illustrating application of an additional transform as an alternate primary transform according to the related art. FIG. 3 is a block diagram illustrating application of an additional transform as a secondary transform according to an exemplary embodiment of the present invention.

Referring to FIG. 2, a transform 201, such as a Discrete Sine Transform (DST) Type-7, may be applied to intra prediction residue as an alternate to primary transform 203. DST Type-7 is determined using Equation (1).

$${[ S ]}_{i , j} = \frac{2}{\sqrt{2 N + 1}} sin \frac{( 2 i - 1 ) j π}{2 N + 1} \qquad Equation ( 1 )$$

In Equation (1), S denotes the DST or alternate primary transform 201, N denotes the block size (e.g., N×N), and i,j are the row and column indices of the 2-d DST matrix. Furthermore, though not a variable in Equation (1), C denotes the conventional DCT Type-2 or primary transform 203.

Based on the mapping for intra prediction modes, or, in general, the direction of prediction, either the primary transform 203 (e.g., DCT (i.e., C)) or the alternate primary transform 201 (e.g., DST (i.e., S)) along a direction for a particular mode can be applied as is illustrated in FIG. 2.

Now, if Tr=C⁻¹*S, and I is an Identity matrix, the application of the Mode-Dependent DCT/DST (respectively C/S) illustrated in FIG. 2, can then equivalently be performed as illustrated in FIG. 3.

Referring to FIG. 3, input intra predicted residue is first submitted to a primary transform 301. Here, as in FIG. 2, the primary transform 301 is illustrated as a DCT Type-2 transform, C. The residue transformed by the primary transform 301 is then directed to either an identity matrix I 303 or a secondary transform Tr 305. It should be noted that multiplication by the identity matrix I 303 in the top branch indicates that no additional steps are required. For the bottom branch in FIG. 3, the input intra predicted residue is first multiplied by primary transform C 301 and then multiplied by secondary transform Tr 305 (i.e., overall as C*Tr=C*C⁻¹*S=S). It should also be noted that since DCT, used as the primary transform 301, is a unitary matrix, C⁻¹=C^{T}, where T denotes the Transpose operation. Further, for the secondary transform 305, if one were to apply a Karhunen-Loeve Transform (KLT) (or any other unitary transform) denoted as K instead of S, Tr would then be Tr=C⁻¹ K.

From the above analysis, it is clear that, mathematically, the application of an alternate primary transform in FIG. 2 and the application of a secondary transform in FIG. 3 are equivalent.

1.2 Steps for Finding a Secondary Transform from an Alternate Primary Transform

An example is now provided regarding the determination of a secondary transform from an alternate primary transform at a size of 8×8. However, the procedure is applicable at any size N×N.

It is assumed that at a size of N×N, N-point DCT and DST are used as alternate primary transforms. For notation purposes, S is appended with the input block-length N to denote N-point DST (i.e., S_{N}). At size 8×8, one can derive an alternate primary transform S₈ or can apply Tr₈ defined as C₈^{T} S₈.

Now, let X be the input. The 8×8 correlation matrix M₁ can be determined as:

$$[ \begin{matrix}1 & 1 & 1 & 1 & 1 & 1 & 1 & 1 \\ 1 & 2 & 2 & 2 & 2 & 2 & 2 & 2 \\ 1 & 2 & 3 & 3 & 3 & 3 & 3 & 3 \\ 1 & 2 & 3 & 4 & 4 & 4 & 4 & 4 \\ 1 & 2 & 3 & 4 & 5 & 5 & 5 & 5 \\ 1 & 2 & 3 & 4 & 5 & 6 & 6 & 6 \\ 1 & 2 & 3 & 4 & 5 & 6 & 7 & 7 \\ 1 & 2 & 3 & 4 & 5 & 6 & 7 & 8\end{matrix} ]$$

Let Y=C₈^{T}*X be the DCT output for the input X. Then, the covariance matrix for Y is given by M₂=C₈^{T}*M₁*C₈.

For the floating point 8×8 DCT, with basis vectors in columns, C₈ is determined as:

$$[ \begin{matrix}0.3536 & 0.4904 & 0.4619 & 0.4157 & 0.3536 & 0.2778 & 0.1913 & 0.0975 \\ 0.3536 & 0.4157 & 0.1913 & - 0.0975 & - 0.3536 & - 0.4904 & - 0.4619 & - 0.2778 \\ 0.3536 & 0.2778 & - 0.1913 & - 0.4904 & - 0.3536 & 0.0975 & 0.4619 & 0.4157 \\ 0.3536 & 0.0975 & - 0.4619 & - 0.2778 & 0.3536 & 0.4157 & - 0.1913 & - 0.4904 \\ 0.3536 & - 0.0975 & - 0.4619 & 0.2778 & 0.3536 & - 0.4157 & - 0.1913 & 0.4904 \\ 0.3536 & - 0.2778 & - 0.1913 & 0.4904 & - 0.3536 & - 0.0975 & 0.4619 & - 0.4157 \\ 0.3536 & - 0.4157 & 0.1913 & 0.0975 & - 0.3536 & 0.4904 & - 0.4619 & 0.2778 \\ 0.3536 & - 0.4904 & 0.4619 & - 0.4157 & 0.3536 & - 0.2778 & 0.1913 & - 0.0975\end{matrix} ]$$

and C₈^{T} is determined as:

$$[ \begin{matrix}0.3536 & 0.3536 & 0.3536 & 0.3536 & 0.3536 & 0.3536 & 0.3536 & 0.3536 \\ 0.4904 & 0.4157 & 0.2778 & 0.0975 & - 0.0975 & - 0.2778 & - 0.4157 & - 0.4904 \\ 0.4619 & 0.1913 & - 0.1913 & - 0.4619 & - 0.4619 & - 0.1913 & 0.1913 & 0.4619 \\ 0.4157 & - 0.0975 & - 0.4904 & - 0.2778 & 0.2778 & 0.4904 & 0.0975 & - 0.4157 \\ 0.3536 & - 0.3536 & - 0.3536 & 0.3536 & 0.3536 & - 0.3536 & - 0.3536 & 0.3536 \\ 0.2778 & - 0.4904 & 0.0975 & 0.4157 & - 0.4157 & - 0.0975 & 0.4904 & - 0.2778 \\ 0.1913 & - 0.4619 & 0.4619 & - 0.1913 & - 0.1913 & 0.4619 & - 0.4619 & 0.1913 \\ 0.0975 & - 0.2778 & 0.4157 & - 0.4904 & 0.4904 & - 0.4157 & 0.2778 & - 0.0975\end{matrix} ]$$

thus, with M₂=C₈^{T}*M₁*C₈, M₂ is determined as:

$$[ \begin{matrix}25.5000 & - 9.1108 & - 2.2304 & - 0.9524 & - 0.5000 & - 0.2841 & - 0.1585 & - 0.0717 \\ - 9.1108 & 6.5685 & 0.0000 & - 0.0000 & - 0.0000 & - 0.0000 & 0.0000 & 0.0000 \\ - 2.2304 & 0.0000 & 1.7071 & 0.0000 & - 0.0000 & - 0.0000 & 0.0000 & 0.0000 \\ - 0.9524 & - 0.0000 & 0.0000 & 0.8100 & 0.0000 & - 0.0000 & 0.0000 & 0.0000 \\ - 0.5000 & - 0.0000 & - 0.0000 & 0.0000 & 0.5000 & - 0.0000 & - 0.0000 & 0.0000 \\ - 0.2841 & - 0.0000 & - 0.0000 & - 0.0000 & - 0.0000 & 0.3616 & 0.0000 & - 0.0000 \\ - 0.1585 & 0.0000 & 0.0000 & 0.0000 & - 0.0000 & 0.0000 & 0.2929 & 0.0000 \\ - 0.0717 & 0.0000 & 0.0000 & 0.0000 & 0.0000 & - 0.0000 & 0.0000 & 0.2599\end{matrix} ]$$

The KLT for this matrix can be found as [A,B]=eig(M₂), wherein A is determined as:

$$[ \begin{matrix}- 0.9254 & 0.3014 & - 0.1722 & 0.1136 & - 0.0782 & 0.0531 & 0.0332 & 0.0160 \\ 0.3698 & 0.8500 & - 0.2955 & 0.1759 & - 0.1165 & 0.0777 & 0.0482 & 0.0231 \\ 0.0746 & - 0.4121 & - 0.8558 & 0.2486 & - 0.1396 & 0.0870 & 0.0522 & 0.0247 \\ 0.0309 & - 0.1135 & 0.3658 & 0.8896 & - 0.2114 & 0.1090 & 0.0606 & 0.0277 \\ 0.0160 & - 0.0531 & 0.1136 & - 0.3014 & - 0.9254 & 0.1722 & 0.0782 & 0.0332 \\ 0.0091 & - 0.0288 & 0.0546 & - 0.0987 & 0.2310 & 0.9565 & 0.1274 & 0.0443 \\ 0.0050 & - 0.0157 & 0.0283 & - 0.0455 & 0.0752 & - 0.1589 & 0.9800 & 0.0744 \\ 0.0023 & - 0.0070 & 0.0124 & - 0.0190 & 0.0283 & - 0.0443 & - 0.0862 & 0.9946\end{matrix} ]$$

and B is determined as:

$$[ \begin{matrix}29.3653 & 0 & 0 & 0 & 0 & 0 & 0 & 0 \\ 0 & 3.3382 & 0 & 0 & 0 & 0 & 0 & 0 \\ 0 & 0 & 1.2583 & 0 & 0 & 0 & 0 & 0 \\ 0 & 0 & 0 & 0.6884 & 0 & 0 & 0 & 0 \\ 0 & 0 & 0 & 0 & 0.4578 & 0 & 0 & 0 \\ 0 & 0 & 0 & 0 & 0 & 0.3458 & 0 & 0 \\ 0 & 0 & 0 & 0 & 0 & 0 & 0.2875 & 0 \\ 0 & 0 & 0 & 0 & 0 & 0 & 0 & 0.2587\end{matrix} ]$$

The transposition of A (i.e., A^{T}) is then rounded and normalized by 128 (i.e., round(A^{T}*128)) which results in:

$$[ \begin{matrix}- 118 & 47 & 10 & 4 & 2 & 1 & 1 & 0 \\ 39 & 109 & - 53 & - 15 & - 7 & - 4 & - 2 & - 1 \\ - 22 & - 38 & - 110 & 47 & 15 & 7 & 4 & 2 \\ 15 & 23 & 32 & 114 & - 39 & - 13 & - 6 & - 2 \\ - 10 & - 15 & - 18 & - 27 & - 118 & 30 & 10 & 4 \\ 7 & 10 & 11 & 14 & 22 & 122 & - 20 & - 6 \\ 4 & 6 & 7 & 8 & 10 & 16 & 125 & - 11 \\ 2 & 3 & 3 & 4 & 4 & 6 & 10 & 127\end{matrix} ]$$

It is further noted that E=round(C₈^{T}*S₈*128)^{T} which is determined as:

$$[ \begin{matrix}118 & - 47 & - 10 & - 4 & - 2 & - 1 & - 1 & 0 \\ 39 & 109 & - 53 & - 15 & - 7 & - 4 & - 2 & - 1 \\ 22 & 38 & 110 & - 47 & - 15 & - 7 & - 4 & - 2 \\ 15 & 23 & 32 & 114 & - 39 & - 13 & - 6 & - 2 \\ 10 & 15 & 18 & 27 & 118 & - 30 & - 10 & - 4 \\ 7 & 10 & 11 & 14 & 22 & 122 & - 20 & - 6 \\ 4 & 6 & 7 & 8 & 10 & 16 & 125 & - 11 \\ 2 & 3 & 3 & 4 & 4 & 6 & 10 & 127\end{matrix} ]$$

where the DST Type 7 matrix S₈ is:

$$\begin{matrix}[ 0.0891 & 0.2554 & 0.3871 & 0.4666 & 0.4830 & 0.4342 & 0.3268 & 0.1752 \\ 0.1752 & 0.4342 & 0.4666 & 0.2554 & - 0.0891 & - 0.3871 & - 0.4830 & - 0.3268 \\ 0.2554 & 0.4830 & 0.1752 & - 0.3268 & - 0.4666 & - 0.0891 & 0.3871 & 0.4342 \\ 0.3268 & 0.3871 & - 0.2554 & - 0.4342 & 0.1752 & 0.4666 & - 0.0891 & - 0.4830 \\ 0.3871 & 0.1752 & - 0.4830 & 0.0891 & 0.4342 & - 0.3268 & - 0.2554 & 0.4666 \\ 0.4342 & - 0.0891 & - 0.3268 & 0.4830 & - 0.2554 & - 0.1752 & 0.4666 & - 0.3871 ] \\ [ 0.4666 & - 0.3268 & 0.0891 & 0.1752 & - 0.3871 & 0.4830 & - 0.4342 & 0.2554 \\ 0.4830 & - 0.4666 & 0.4342 & - 0.3871 & 0.3268 & - 0.2554 & 0.1752 & - 0.0891 ]\end{matrix}$$

and S₈^{T} is determined as:

$$\begin{matrix}[ 0.0891 & 0.1752 & 0.2554 & 0.3268 & 0.3871 & 0.4342 & 0.4666 & 0.4830 \\ 0.2554 & 0.4342 & 0.4830 & 0.3871 & 0.1752 & - 0.0891 & - 0.3268 & - 0.4666 \\ 0.3871 & 0.4666 & 0.1752 & - 0.2554 & - 0.4830 & - 0.3268 & 0.0891 & 0.4342 \\ 0.4666 & 0.2554 & - 0.3268 & - 0.4342 & 0.0891 & 0.4830 & 0.1752 & - 0.3871 \\ 0.4830 & - 0.0891 & - 0.4666 & 0.1752 & 0.4342 & - 0.2554 & - 0.3871 & 0.3268 \\ 0.4342 & - 0.3871 & - 0.0891 & 0.4666 & - 0.3268 & - 0.1752 & 0.4830 & - 0.2554 \\ 0.3268 & - 0.4830 & 0.3871 & - 0.0891 & - 0.2554 & 0.4666 & - 0.4342 & 0.1752 \\ 0.1752 & - 0.3268 & 0.4342 & - 0.4830 & 0.4666 & - 0.3871 & 0.2554 & - 0.0891 ]\end{matrix}$$

In the above matrix E, the basis vectors are along columns. Hence, ignoring the sign of the basis vectors (i.e., if m is a basis vector, so is −m), it can be concluded that A=E^{T}=C₈^{T}*S₈ is a secondary matrix Tr based on the earlier definition of Tr=C^{T}*S.

The above analysis shows that there is one-to-one mathematical equivalence between a primary alternate transform and a secondary transform.

### 1.3 Benefits of Secondary Transform

It could be argued that because both of these mathematically equivalent techniques of applying a primary alternate transform and applying a secondary transform, for example at size 8×8, require another 8×8 matrix in addition to 8-point DCT C₈, neither provides an advantage over the other. Additionally, the secondary transform as in FIG. 3 may require a greater number of multiplications and additions since multiplication is first by C and then by Tr. However, the secondary transform approach in FIG. 3 has an important advantage in that it can be re-used across various block sizes, while a primary alternate transform can not.

For example, the same 8×8 matrix A can be used again as a secondary matrix for the 8×8 lowest frequency band following the 16×16 and 32×32 DCT. This results in several advantages. For example, there is no need for additional storage at larger blocks (e.g., 16×16 and higher) for storing any of the new alternate or secondary transforms. Further, B=C₄^{T}*S₄ can be used as a 4×4 secondary transform at all block sizes of 8×8 and higher, which can be derived from the DCT and DST at block sizes of 4×4. At a block size of 4×4, it would be beneficial to apply S₄ directly so as to minimize the number of operations.

In an exemplary implementation, B, in which the basis vector is normalized by 128, is derived as illustrated below.

B (shifted by 7 bits)=round (C₄^{T}*S₄) with norm scaled to 128, which is determined as:

$$\begin{matrix}[ 121 & 37 & 18 & 8 \\ - 41 & 117 & 31 & 12 \\ - 8 & - 37 & 121 & 18 \\ - 2 & - 8 & - 21 & 126 ]\end{matrix}$$

Based on a DCT operation, C₄ may be determined as:

$$\begin{matrix}[ 64 & 83 & 64 & 36 \\ 64 & 36 & - 64 & - 83 \\ 64 & - 36 & - 64 & 83 \\ 64 & - 83 & 64 & - 36 ]\end{matrix}$$

and B would then be round(C₄^{T}*S), which is determined as:

$$\begin{matrix}[ 121 & 37 & 18 & 8 \\ - 41 & 117 & 32 & 10 \\ - 8 & - 37 & 121 & 18 \\ - 3 & - 6 & - 21 & 126 ]\end{matrix}$$

If S₁ is already 7-bit rounded DST in High Efficiency Video Coding (HEVC) test Model (HM) 3.0, it is determined as:

$$\begin{matrix}[ 29 & 74 & 84 & 55 \\ 55 & 74 & - 29 & - 84 \\ 74 & 0 & - 74 & 74 \\ 84 & - 74 & 55 & - 29 ]\end{matrix}$$

then B could also be found as round(C₄^{T}*S₁/128), which is determined as:

$$\begin{matrix}[ 121 & 37 & 18 & 8 \\ - 41 & 117 & 31 & 10 \\ - 8 & - 37 & 121 & 18 \\ - 3 & - 6 & - 21 & 126 ]\end{matrix}$$

Also, for a case of (28,56) approximate DST, then S₂ is determined as:

$$\begin{matrix}[ 28 & 74 & 84 & 56 \\ 56 & 74 & - 28 & - 84 \\ 74 & 0 & - 74 & 74 \\ 84 & - 74 & 56 & - 28 ]\end{matrix}$$

And B=round(C₄^{T}*S₂/128) is determined as:

$$\begin{matrix}[ 121 & 37 & 19 & 9 \\ - 41 & 117 & 31 & 10 \\ - 9 & - 37 & 121 & 19 \\ - 4 & - 6 & - 22 & 126 ]\end{matrix}$$

It is noted that the application of B as a secondary transform at all block-sizes makes the design very consistent. Also, B can be applied as a cascade of the transforms C₄^{T} and S, via two consecutive matrices. If that is the case, the number of multiplications (mults) required would be only mults (DCT_{4×4})+mults (Sin_{4×4}) rather than full matrix multiplication (i.e., 16 for a 4×4 case).

In the current HM, the number of multiplications for DST is 8, and (28,56) DST has 5 multiplications. A 4×4 point DCT using a butterfly structure can be applied using 4*log(4) mults=8 mults, and hence the total would be 13 mults for implementation of B, which is less than full matrix multiplication. Also, there would be no requirement of any new transform in that case. Such a procedure is applicable even if the DCT at size 4×4 or DST at size 4×4 changes in the future, or if DST is replaced by a new 4×4 KLT.

### 1.4 Secondary Transforms by Smoothing the Correlation Matrix for 8 Intra Prediction Blocks

It is also noted that the covariance matrix M for an intra block with dimension 8, along which the prediction is performed, can be changed. For example, the covariance matrix M may be changed to allow for smoothness for higher order blocks. In that case, M_{1,new} may be determined as:

$$\begin{matrix}[ 1 & 1 & 1 & 1 & 1 & 1 & 1 & 1 \\ 1 & 1.5 & 1.5 & 1.5 & 1.5 & 1.5 & 1.5 & 1.5 \\ 1 & 1.5 & 2 & 2 & 2 & 2 & 2 & 2 \\ 1 & 1.5 & 2 & 2.5 & 2.5 & 2.5 & 2.5 & 2.5 \\ 1 & 1.5 & 2 & 2.5 & 3 & 3 & 3 & 3 \\ 1 & 1.5 & 2 & 2.5 & 3 & 3.5 & 3.5 & 3.5 \\ 1 & 1.5 & 2 & 2.5 & 3 & 3.5 & 4 & 4 \\ 1 & 1.5 & 2 & 2.5 & 3 & 3.5 & 4 & 4.5 ]\end{matrix}$$

Then, M_{2,new}=C₈^{T}*M_{1,new}*C₈, which is determined as:

$$\begin{matrix}[ 16.7500 & - 4.5554 & - 1.1152 & - 0.4762 & - 0.2500 & - 0.1421 & - 0.0793 & - 0.0359 \\ - 4.5554 & 3.2843 & 0.0000 & - 0.0000 & - 0.0000 & - 0.0000 & 0.0000 & 0.0000 \\ - 1.1152 & 0.0000 & 0.8536 & 0.0000 & - 0.0000 & - 0.0000 & 0.0000 & 0.0000 \\ - 0.4762 & - 0.0000 & 0.0000 & 0.4050 & 0.0000 & - 0.0000 & 0.0000 & 0.0000 \\ - 0.2500 & - 0.0000 & - 0.0000 & 0.0000 & 0.2500 & - 0.0000 & - 0.0000 & 0.0000 \\ - 0.1421 & - 0.0000 & - 0.0000 & - 0.0000 & - 0.0000 & 0.1808 & 0.0000 & - 0.0000 \\ - 0.0793 & 0.0000 & 0.0000 & 0.0000 & - 0.0000 & 0.0000 & 0.1464 & 0.0000 \\ - 0.0359 & 0.0000 & 0.0000 & 0.0000 & 0.0000 & - 0.0000 & 0.0000 & 0.1299 ]\end{matrix}$$

The KLT for M₂ may be determined as [P,Q]=eig(M₂), wherein P is determined as:

$$\begin{matrix}[ 0.9543 & 0.2627 & - 0.1192 & 0.0635 & - 0.0368 & 0.0220 & 0.0126 & 0.0058 \\ - 0.2909 & 0.9254 & - 0.2112 & 0.0993 & - 0.0551 & 0.0322 & 0.0183 & 0.0083 \\ - 0.0613 & - 0.2576 & - 0.9497 & 0.1476 & - 0.0669 & 0.0363 & 0.0198 & 0.0089 \\ - 0.0255 & - 0.0789 & 0.1839 & 0.9722 & - 0.1066 & 0.0460 & 0.0231 & 0.0100 \\ - 0.0133 & - 0.0377 & 0.0643 & - 0.1281 & - 0.9854 & 0.0759 & 0.0301 & 0.0120 \\ - 0.0075 & - 0.0206 & 0.0318 & - 0.0467 & 0.0873 & 0.9929 & 0.0506 & 0.0161 \\ - 0.0042 & - 0.0113 & 0.0167 & - 0.0221 & 0.0309 & - 0.0558 & 0.9971 & 0.0274 \\ - 0.0019 & - 0.0051 & 0.0073 & - 0.0093 & 0.0119 & - 0.0165 & - 0.0291 & 0.9993 ]\end{matrix}$$

Q is determined as:

$$\begin{matrix}[ 18.2280 & 0 & 0 & 0 & 0 & 0 & 0 & 0 \\ 0 & 1.9910 & 0 & 0 & 0 & 0 & 0 & 0 \\ 0 & 0 & 0.7136 & 0 & 0 & 0 & 0 & 0 \\ 0 & 0 & 0 & 0.3739 & 0 & 0 & 0 & 0 \\ 0 & 0 & 0 & 0 & 0.2407 & 0 & 0 & 0 \\ 0 & 0 & 0 & 0 & 0 & 0.1777 & 0 & 0 ] \\ [ 0 & 0 & 0 & 0 & 0 & 0 & 0.1454 & 0 \\ 0 & 0 & 0 & 0 & 0 & 0 & 0 & 0.1297 ]\end{matrix}$$

and T₂=round(P^{T}*128), which is determined as,

$$\begin{matrix}[ 122 & - 37 & - 8 & - 3 & - 2 & - 1 & - 1 & 0 \\ 34 & 118 & - 33 & - 10 & - 5 & - 3 & - 1 & - 1 \\ - 15 & - 27 & - 122 & 24 & 8 & 4 & 2 & 1 \\ 8 & 13 & 19 & 124 & - 16 & - 6 & - 3 & - 1 \\ - 5 & - 7 & - 9 & - 14 & - 126 & 11 & 4 & 2 \\ 3 & 4 & 5 & 6 & 10 & 127 & - 7 & - 2 \\ 2 & 2 & 3 & 3 & 4 & 6 & 128 & - 4 \\ 1 & 1 & 1 & 1 & 2 & 2 & 4 & 128 ]\end{matrix}$$

can also be used as a secondary transform. Of course, this is merely an example and it should be understood that the above procedure can be applied with any covariance matrix which has similar characteristics such as M₃ which is determined as:

$$\begin{matrix}[ 1.0000 & 1.0000 & 1.0000 & 1.0000 & 1.0000 & 1.0000 & 1.0000 & 1.0000 \\ 1.0000 & 1.4000 & 1.4000 & 1.4000 & 1.4000 & 1.4000 & 1.4000 & 1.4000 \\ 1.0000 & 1.4000 & 1.8000 & 1.8000 & 1.8000 & 1.8000 & 1.8000 & 1.8000 \\ 1.0000 & 1.4000 & 1.8000 & 2.2000 & 2.2000 & 2.2000 & 2.2000 & 2.2000 \\ 1.0000 & 1.4000 & 1.8000 & 2.2000 & 2.6000 & 2.6000 & 2.6000 & 2.6000 \\ 1.0000 & 1.4000 & 1.8000 & 2.2000 & 2.6000 & 3.0000 & 3.0000 & 3.0000 \\ 1.0000 & 1.4000 & 1.8000 & 2.2000 & 2.6000 & 3.0000 & 3.4000 & 3.4000 \\ 1.0000 & 1.4000 & 1.8000 & 2.2000 & 2.6000 & 3.0000 & 3.4000 & 3.8000 ]\end{matrix}$$

where the slope of the diagonal unique elements in M₃ is varied in a different fashion.

### 1.5 Secondary Transforms by Smoothing the Correlation Matrix for Dimension 16, 32 and Other Intra Prediction Blocks

For deriving an 8-point transform (e.g., vertical transform after vertical prediction on intra blocks with vertical dimension of 8), the following covariance matrix M_{1,new} may be used after smoothing as described in Section 1.4, where M_{1,new} is determined as:

$$\begin{matrix}[ 1 & 1 & 1 & 1 & 1 & 1 & 1 & 1 \\ 1 & 1.5 & 1.5 & 1.5 & 1.5 & 1.5 & 1.5 & 1.5 \\ 1 & 1.5 & 2 & 2 & 2 & 2 & 2 & 2 \\ 1 & 1.5 & 2 & 2.5 & 2.5 & 2.5 & 2.5 & 2.5 \\ 1 & 1.5 & 2 & 2.5 & 3 & 3 & 3 & 3 \\ 1 & 1.5 & 2 & 2.5 & 3 & 3.5 & 3.5 & 3.5 \\ 1 & 1.5 & 2 & 2.5 & 3 & 3.5 & 4 & 4 \\ 1 & 1.5 & 2 & 2.5 & 3 & 3.5 & 4 & 4.5 ]\end{matrix}$$

The above correlation matrix may be denoted as R₈=M_{1,new} for notational simplicity, where the sub-script denotes the dimension 8 corresponding to the input vector length.

A correlation matrix for intra 4×4 blocks for deriving an optimal transform is shown by R₄ below.

$${R}_{4} = [ \begin{matrix}1 & 1 & 1 & 1 \\ 1 & 2 & 2 & 2 \\ 1 & 2 & 3 & 3 \\ 1 & 2 & 3 & 4\end{matrix} ]$$

Noting the similarity between R₈ and R₄, the following Equation (2), including smoothing for term (i,j) of the N×N matrix of intra prediction residue block R_{N}, is proposed.

p=min(i,j)

R_{N}(i,j)=1+(p−1)/(N/4) Equation (2)

It is noted that in Equation (2), the slope factor (p−1)/(N/4) can be generalized to β(p−1)/(N/4). In that case, β, which is a positive real number, can further control the slope for smoothing the elements of the correlation matrix R_{N}. Possible values of β include 0.6, 0.8, 1.2, etc.

It is also noted that all the correlation matrices R₄, R₈, R₁₆, R₃₂ are simply special cases of the above N×N matrix R_{N}. For example, the R₁₆ matrix would be determined as:

$${R}_{16} = [ \begin{matrix}1 & 1 & 1 & 1 & 1 & 1 & 1 & 1 & 1 & 1 & 1 & 1 & 1 & 1 & 1 & 1 \\ 1 & 1.25 & 1.25 & 1.25 & 1.25 & 1.25 & 1.25 & 1.25 & 1.25 & 1.25 & 1.25 & 1.25 & 1.25 & 1.25 & 1.25 & 1.25 \\ 1 & 1.25 & 1.5 & 1.5 & 1.5 & 1.5 & 1.5 & 1.5 & 1.5 & 1.5 & 1.5 & 1.5 & 1.5 & 1.5 & 1.5 & 1.5 \\ 1 & 1.25 & 1.5 & 1.75 & 1.75 & 1.75 & 1.75 & 1.75 & 1.75 & 1.75 & 1.75 & 1.75 & 1.75 & 1.75 & 1.75 & 1.75 \\ 1 & 1.25 & 1.5 & 1.75 & 2 & 2 & 2 & 2 & 2 & 2 & 2 & 2 & 2 & 2 & 2 & 2 \\ 1 & 1.25 & 1.5 & 1.75 & 2 & 2.25 & 2.25 & 2.25 & 2.25 & 2.25 & 2.25 & 2.25 & 2.25 & 2.25 & 2.25 & 2.25 \\ 1 & 1.25 & 1.5 & 1.75 & 2 & 2.25 & 2.5 & 2.5 & 2.5 & 2.5 & 2.5 & 2.5 & 2.5 & 2.5 & 2.5 & 2.5 \\ 1 & 1.25 & 1.5 & 1.75 & 2 & 2.25 & 2.5 & 2.75 & 2.75 & 2.75 & 2.75 & 2.75 & 2.75 & 2.75 & 2.75 & 2.75 \\ 1 & 1.25 & 1.5 & 1.75 & 2 & 2.25 & 2.5 & 2.75 & 3 & 3 & 3 & 3 & 3 & 3 & 3 & 3 \\ 1 & 1.25 & 1.5 & 1.75 & 2 & 2.25 & 2.5 & 2.75 & 3 & 3.25 & 3.25 & 3.25 & 3.25 & 3.25 & 3.25 & 3.25 \\ 1 & 1.25 & 1.5 & 1.75 & 2 & 2.25 & 2.5 & 2.75 & 3 & 3.25 & 3.5 & 3.5 & 3.5 & 3.5 & 3.5 & 3.5 \\ 1 & 1.25 & 1.5 & 1.75 & 2 & 2.25 & 2.5 & 2.75 & 3 & 3.25 & 3.5 & 3.5 & 3.5 & 3.5 & 3.5 & 3.5 \\ 1 & 1.25 & 1.5 & 1.75 & 2 & 2.25 & 2.5 & 2.75 & 3 & 3.25 & 3.5 & 3.75 & 4 & 4 & 4 & 4 \\ 1 & 1.25 & 1.5 & 1.75 & 2 & 2.25 & 2.5 & 2.75 & 3 & 3.25 & 3.5 & 3.75 & 4 & 4.25 & 4.25 & 4.25 \\ 1 & 1.25 & 1.5 & 1.75 & 2 & 2.25 & 2.5 & 2.75 & 3 & 3.25 & 3.5 & 3.75 & 4 & 4.25 & 4.5 & 4.5 \\ 1 & 1.25 & 1.5 & 1.75 & 2 & 2.25 & 2.5 & 2.75 & 3 & 3.25 & 3.5 & 3.75 & 4 & 4.25 & 4.5 & 4.75\end{matrix} ]$$

And the R₃₂ matrix would be determined as:

### Columns 1 Through 10

| | | | | | | | | | |
|---|---|---|---|---|---|---|---|---|---|
| [1.0000 | 1.0000 | 1.0000 | 1.0000 | 1.0000 | 1.0000 | 1.0000 | 1.0000 | 1.0000 | 1.0000 |
| 1.0000 | 1.1250 | 1.1250 | 1.1250 | 1.1250 | 1.1250 | 1.1250 | 1.1250 | 1.1250 | 1.1250 |
| 1.0000 | 1.1250 | 1.2500 | 1.2500 | 1.2500 | 1.2500 | 1.2500 | 1.2500 | 1.2500 | 1.2500 |
| 1.0000 | 1.1250 | 1.2500 | 1.3750 | 1.3750 | 1.3750 | 1.3750 | 1.3750 | 1.3750 | 1.3750 |
| 1.0000 | 1.1250 | 1.2500 | 1.3750 | 1.5000 | 1.5000 | 1.5000 | 1.5000 | 1.5000 | 1.5000 |
| 1.0000 | 1.1250 | 1.2500 | 1.3750 | 1.5000 | 1.6250 | 1.6250 | 1.6250 | 1.6250 | 1.6250 |
| 1.0000 | 1.1250 | 1.2500 | 1.3750 | 1.5000 | 1.6250 | 1.7500 | 1.7500 | 1.7500 | 1.7500 |
| 1.0000 | 1.1250 | 1.2500 | 1.3750 | 1.5000 | 1.6250 | 1.7500 | 1.8750 | 1.8750 | 1.8750 |
| 1.0000 | 1.1250 | 1.2500 | 1.3750 | 1.5000 | 1.6250 | 1.7500 | 1.8750 | 2.0000 | 2.0000 |
| 1.0000 | 1.1250 | 1.2500 | 1.3750 | 1.5000 | 1.6250 | 1.7500 | 1.8750 | 2.0000 | 2.1250 |
| 1.0000 | 1.1250 | 1.2500 | 1.3750 | 1.5000 | 1.6250 | 1.7500 | 1.8750 | 2.0000 | 2.1250 |
| 1.0000 | 1.1250 | 1.2500 | 1.3750 | 1.5000 | 1.6250 | 1.7500 | 1.8750 | 2.0000 | 2.1250 |
| 1.0000 | 1.1250 | 1.2500 | 1.3750 | 1.5000 | 1.6250 | 1.7500 | 1.8750 | 2.0000 | 2.1250 |
| 1.0000 | 1.1250 | 1.2500 | 1.3750 | 1.5000 | 1.6250 | 1.7500 | 1.8750 | 2.0000 | 2.1250 |
| 1.0000 | 1.1250 | 1.2500 | 1.3750 | 1.5000 | 1.6250 | 1.7500 | 1.8750 | 2.0000 | 2.1250 |
| 1.0000 | 1.1250 | 1.2500 | 1.3750 | 1.5000 | 1.6250 | 1.7500 | 1.8750 | 2.0000 | 2.1250 |
| 1.0000 | 1.1250 | 1.2500 | 1.3750 | 1.5000 | 1.6250 | 1.7500 | 1.8750 | 2.0000 | 2.1250 |
| 1.0000 | 1.1250 | 1.2500 | 1.3750 | 1.5000 | 1.6250 | 1.7500 | 1.8750 | 2.0000 | 2.1250 |
| 1.0000 | 1.1250 | 1.2500 | 1.3750 | 1.5000 | 1.6250 | 1.7500 | 1.8750 | 2.0000 | 2.1250 |
| 1.0000 | 1.1250 | 1.2500 | 1.3750 | 1.5000 | 1.6250 | 1.7500 | 1.8750 | 2.0000 | 2.1250 |
| 1.0000 | 1.1250 | 1.2500 | 1.3750 | 1.5000 | 1.6250 | 1.7500 | 1.8750 | 2.0000 | 2.1250 |
| 1.0000 | 1.1250 | 1.2500 | 1.3750 | 1.5000 | 1.6250 | 1.7500 | 1.8750 | 2.0000 | 2.1250 |
| 1.0000 | 1.1250 | 1.2500 | 1.3750 | 1.5000 | 1.6250 | 1.7500 | 1.8750 | 2.0000 | 2.1250 |
| 1.0000 | 1.1250 | 1.2500 | 1.3750 | 1.5000 | 1.6250 | 1.7500 | 1.8750 | 2.0000 | 2.1250 |
| 1.0000 | 1.1250 | 1.2500 | 1.3750 | 1.5000 | 1.6250 | 1.7500 | 1.8750 | 2.0000 | 2.1250 |
| 1.0000 | 1.1250 | 1.2500 | 1.3750 | 1.5000 | 1.6250 | 1.7500 | 1.8750 | 2.0000 | 2.1250 |
| 1.0000 | 1.1250 | 1.2500 | 1.3750 | 1.5000 | 1.6250 | 1.7500 | 1.8750 | 2.0000 | 2.1250 |
| 1.0000 | 1.1250 | 1.2500 | 1.3750 | 1.5000 | 1.6250 | 1.7500 | 1.8750 | 2.0000 | 2.1250 |
| 1.0000 | 1.1250 | 1.2500 | 1.3750 | 1.5000 | 1.6250 | 1.7500 | 1.8750 | 2.0000 | 2.1250 |
| 1.0000 | 1.1250 | 1.2500 | 1.3750 | 1.5000 | 1.6250 | 1.7500 | 1.8750 | 2.0000 | 2.1250 |
| 1.0000 | 1.1250 | 1.2500 | 1.3750 | 1.5000 | 1.6250 | 1.7500 | 1.8750 | 2.0000 | 2.1250 |
| 1.0000 | 1.1250 | 1.2500 | 1.3750 | 1.5000 | 1.6250 | 1.7500 | 1.8750 | 2.0000 | 2.1250 |

### Columns 11 Through 21

| | | | | | | | | | | |
|---|---|---|---|---|---|---|---|---|---|---|
| 1.0000 | 1.0000 | 1.0000 | 1.0000 | 1.0000 | 1.0000 | 1.0000 | 1.0000 | 1.0000 | 1.0000 | 1.0000 |
| 1.1250 | 1.1250 | 1.1250 | 1.1250 | 1.1250 | 1.1250 | 1.1250 | 1.1250 | 1.1250 | 1.1250 | 1.1250 |
| 1.2500 | 1.2500 | 1.2500 | 1.2500 | 1.2500 | 1.2500 | 1.2500 | 1.2500 | 1.2500 | 1.2500 | 1.2500 |
| 1.3750 | 1.3750 | 1.3750 | 1.3750 | 1.3750 | 1.3750 | 1.3750 | 1.3750 | 1.3750 | 1.3750 | 1.3750 |
| 1.5000 | 1.5000 | 1.5000 | 1.5000 | 1.5000 | 1.5000 | 1.5000 | 1.5000 | 1.5000 | 1.5000 | 1.5000 |
| 1.6250 | 1.6250 | 1.6250 | 1.6250 | 1.6250 | 1.6250 | 1.6250 | 1.6250 | 1.6250 | 1.6250 | 1.6250 |
| 1.7500 | 1.7500 | 1.7500 | 1.7500 | 1.7500 | 1.7500 | 1.7500 | 1.7500 | 1.7500 | 1.7500 | 1.7500 |
| 1.8750 | 1.8750 | 1.8750 | 1.8750 | 1.8750 | 1.8750 | 1.8750 | 1.8750 | 1.8750 | 1.8750 | 1.8750 |
| 2.0000 | 2.0000 | 2.0000 | 2.0000 | 2.0000 | 2.0000 | 2.0000 | 2.0000 | 2.0000 | 2.0000 | 2.0000 |
| 2.1250 | 2.1250 | 2.1250 | 2.1250 | 2.1250 | 2.1250 | 2.1250 | 2.1250 | 2.1250 | 2.1250 | 2.1250 |
| 2.2500 | 2.2500 | 2.2500 | 2.2500 | 2.2500 | 2.2500 | 2.2500 | 2.2500 | 2.2500 | 2.2500 | 2.2500 |
| 2.2500 | 2.3750 | 2.3750 | 2.3750 | 2.3750 | 2.3750 | 2.3750 | 2.3750 | 2.3750 | 2.3750 | 2.3750 |
| 2.2500 | 2.3750 | 2.5000 | 2.5000 | 2.5000 | 2.5000 | 2.5000 | 2.5000 | 2.5000 | 2.5000 | 2.5000 |
| 2.2500 | 2.3750 | 2.5000 | 2.6250 | 2.6250 | 2.6250 | 2.6250 | 2.6250 | 2.6250 | 2.6250 | 2.6250 |
| 2.2500 | 2.3750 | 2.5000 | 2.6250 | 2.7500 | 2.7500 | 2.7500 | 2.7500 | 2.7500 | 2.7500 | 2.7500 |
| 2.2500 | 2.3750 | 2.5000 | 2.6250 | 2.7500 | 2.8750 | 2.8750 | 2.8750 | 2.8750 | 2.8750 | 2.8750 |
| 2.2500 | 2.3750 | 2.5000 | 2.6250 | 2.7500 | 2.8750 | 3.0000 | 3.0000 | 3.0000 | 3.0000 | 3.0000 |
| 2.2500 | 2.3750 | 2.5000 | 2.6250 | 2.7500 | 2.8750 | 3.0000 | 3.1250 | 3.1250 | 3.1250 | 3.1250 |
| 2.2500 | 2.3750 | 2.5000 | 2.6250 | 2.7500 | 2.8750 | 3.0000 | 3.1250 | 3.2500 | 3.2500 | 3.2500 |
| 2.2500 | 2.3750 | 2.5000 | 2.6250 | 2.7500 | 2.8750 | 3.0000 | 3.1250 | 3.2500 | 3.3750 | 3.3750 |
| 2.2500 | 2.3750 | 2.5000 | 2.6250 | 2.7500 | 2.8750 | 3.0000 | 3.1250 | 3.2500 | 3.3750 | 3.5000 |
| 2.2500 | 2.3750 | 2.5000 | 2.6250 | 2.7500 | 2.8750 | 3.0000 | 3.1250 | 3.2500 | 3.3750 | 3.5000 |
| 2.2500 | 2.3750 | 2.5000 | 2.6250 | 2.7500 | 2.8750 | 3.0000 | 3.1250 | 3.2500 | 3.3750 | 3.5000 |
| 2.2500 | 2.3750 | 2.5000 | 2.6250 | 2.7500 | 2.8750 | 3.0000 | 3.1250 | 3.2500 | 3.3750 | 3.5000 |
| 2.2500 | 2.3750 | 2.5000 | 2.6250 | 2.7500 | 2.8750 | 3.0000 | 3.1250 | 3.2500 | 3.3750 | 3.5000 |
| 2.2500 | 2.3750 | 2.5000 | 2.6250 | 2.7500 | 2.8750 | 3.0000 | 3.1250 | 3.2500 | 3.3750 | 3.5000 |
| 2.2500 | 2.3750 | 2.5000 | 2.6250 | 2.7500 | 2.8750 | 3.0000 | 3.1250 | 3.2500 | 3.3750 | 3.5000 |
| 2.2500 | 2.3750 | 2.5000 | 2.6250 | 2.7500 | 2.8750 | 3.0000 | 3.1250 | 3.2500 | 3.3750 | 3.5000 |
| 2.2500 | 2.3750 | 2.5000 | 2.6250 | 2.7500 | 2.8750 | 3.0000 | 3.1250 | 3.2500 | 3.3750 | 3.5000 |
| 2.2500 | 2.3750 | 2.5000 | 2.6250 | 2.7500 | 2.8750 | 3.0000 | 3.1250 | 3.2500 | 3.3750 | 3.5000 |
| 2.2500 | 2.3750 | 2.5000 | 2.6250 | 2.7500 | 2.8750 | 3.0000 | 3.1250 | 3.2500 | 3.3750 | 3.5000 |
| 2.2500 | 2.3750 | 2.5000 | 2.6250 | 2.7500 | 2.8750 | 3.0000 | 3.1250 | 3.2500 | 3.3750 | 3.5000 |

### Columns 22 Through 32

| | | | | | | | | | | |
|---|---|---|---|---|---|---|---|---|---|---|
| 1.0000 | 1.0000 | 1.0000 | 1.0000 | 1.0000 | 1.0000 | 1.0000 | 1.0000 | 1.0000 | 1.0000 | 1.0000 |
| 1.1250 | 1.1250 | 1.1250 | 1.1250 | 1.1250 | 1.1250 | 1.1250 | 1.1250 | 1.1250 | 1.1250 | 1.1250 |
| 1.2500 | 1.2500 | 1.2500 | 1.2500 | 1.2500 | 1.2500 | 1.2500 | 1.2500 | 1.2500 | 1.2500 | 1.2500 |
| 1.3750 | 1.3750 | 1.3750 | 1.3750 | 1.3750 | 1.3750 | 1.3750 | 1.3750 | 1.3750 | 1.3750 | 1.3750 |
| 1.5000 | 1.5000 | 1.5000 | 1.5000 | 1.5000 | 1.5000 | 1.5000 | 1.5000 | 1.5000 | 1.5000 | 1.5000 |
| 1.6250 | 1.6250 | 1.6250 | 1.6250 | 1.6250 | 1.6250 | 1.6250 | 1.6250 | 1.6250 | 1.6250 | 1.6250 |
| 1.7500 | 1.7500 | 1.7500 | 1.7500 | 1.7500 | 1.7500 | 1.7500 | 1.7500 | 1.7500 | 1.7500 | 1.7500 |
| 1.8750 | 1.8750 | 1.8750 | 1.8750 | 1.8750 | 1.8750 | 1.8750 | 1.8750 | 1.8750 | 1.8750 | 1.8750 |
| 2.0000 | 2.0000 | 2.0000 | 2.0000 | 2.0000 | 2.0000 | 2.0000 | 2.0000 | 2.0000 | 2.0000 | 2.0000 |
| 2.1250 | 2.1250 | 2.1250 | 2.1250 | 2.1250 | 2.1250 | 2.1250 | 2.1250 | 2.1250 | 2.1250 | 2.1250 |
| 2.2500 | 2.2500 | 2.2500 | 2.2500 | 2.2500 | 2.2500 | 2.2500 | 2.2500 | 2.2500 | 2.2500 | 2.2500 |
| 2.3750 | 2.3750 | 2.3750 | 2.3750 | 2.3750 | 2.3750 | 2.3750 | 2.3750 | 2.3750 | 2.3750 | 2.3750 |
| 2.5000 | 2.5000 | 2.5000 | 2.5000 | 2.5000 | 2.5000 | 2.5000 | 2.5000 | 2.5000 | 2.5000 | 2.5000 |
| 2.6250 | 2.6250 | 2.6250 | 2.6250 | 2.6250 | 2.6250 | 2.6250 | 2.6250 | 2.6250 | 2.6250 | 2.6250 |
| 2.7500 | 2.7500 | 2.7500 | 2.7500 | 2.7500 | 2.7500 | 2.7500 | 2.7500 | 2.7500 | 2.7500 | 2.7500 |
| 2.8750 | 2.8750 | 2.8750 | 2.8750 | 2.8750 | 2.8750 | 2.8750 | 2.8750 | 2.8750 | 2.8750 | 2.8750 |
| 3.0000 | 3.0000 | 3.0000 | 3.0000 | 3.0000 | 3.0000 | 3.0000 | 3.0000 | 3.0000 | 3.0000 | 3.0000 |
| 3.1250 | 3.1250 | 3.1250 | 3.1250 | 3.1250 | 3.1250 | 3.1250 | 3.1250 | 3.1250 | 3.1250 | 3.1250 |
| 3.2500 | 3.2500 | 3.2500 | 3.2500 | 3.2500 | 3.2500 | 3.2500 | 3.2500 | 3.2500 | 3.2500 | 3.2500 |
| 3.3750 | 3.3750 | 3.3750 | 3.3750 | 3.3750 | 3.3750 | 3.3750 | 3.3750 | 3.3750 | 3.3750 | 3.3750 |
| 3.5000 | 3.5000 | 3.5000 | 3.5000 | 3.5000 | 3.5000 | 3.5000 | 3.5000 | 3.5000 | 3.5000 | 3.5000 |
| 3.6250 | 3.6250 | 3.6250 | 3.6250 | 3.6250 | 3.6250 | 3.6250 | 3.6250 | 3.6250 | 3.6250 | 3.6250 |
| 3.6250 | 3.7500 | 3.7500 | 3.7500 | 3.7500 | 3.7500 | 3.7500 | 3.7500 | 3.7500 | 3.7500 | 3.7500 |
| 3.6250 | 3.7500 | 3.8750 | 3.8750 | 3.8750 | 3.8750 | 3.8750 | 3.8750 | 3.8750 | 3.8750 | 3.8750 |
| 3.6250 | 3.7500 | 3.8750 | 4.0000 | 4.0000 | 4.0000 | 4.0000 | 4.0000 | 4.0000 | 4.0000 | 4.0000 |
| 3.6250 | 3.7500 | 3.8750 | 4.0000 | 4.1250 | 4.1250 | 4.1250 | 4.1250 | 4.1250 | 4.1250 | 4.1250 |
| 3.6250 | 3.7500 | 3.8750 | 4.0000 | 4.1250 | 4.2500 | 4.2500 | 4.2500 | 4.2500 | 4.2500 | 4.2500 |
| 3.6250 | 3.7500 | 3.8750 | 4.0000 | 4.1250 | 4.2500 | 4.3750 | 4.3750 | 4.3750 | 4.3750 | 4.3750 |
| 3.6250 | 3.7500 | 3.8750 | 4.0000 | 4.1250 | 4.2500 | 4.3750 | 4.5000 | 4.5000 | 4.5000 | 4.5000 |
| 3.6250 | 3.7500 | 3.8750 | 4.0000 | 4.1250 | 4.2500 | 4.3750 | 4.5000 | 4.6250 | 4.6250 | 4.6250 |
| 3.6250 | 3.7500 | 3.8750 | 4.0000 | 4.1250 | 4.2500 | 4.3750 | 4.5000 | 4.6250 | 4.7500 | 4.7500 |
| 3.6250 | 3.7500 | 3.8750 | 4.0000 | 4.1250 | 4.2500 | 4.3750 | 4.5000 | 4.6250 | 4.7500 | 4.8750] |

Although not illustrated, R₄₈ or R₆₄ can be calculated in a similar fashion.

### 1.6 Steps for Deriving Secondary Transform

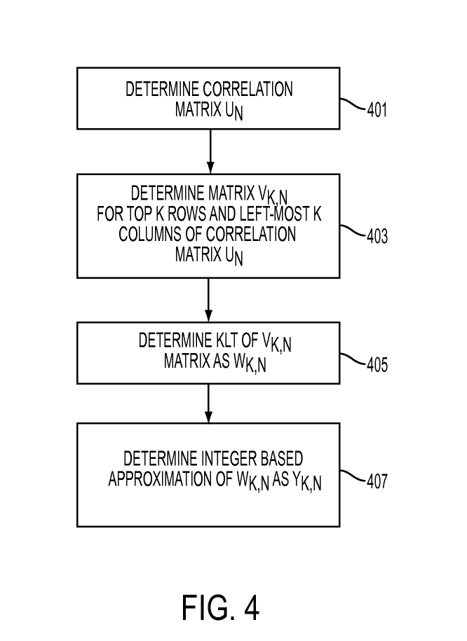

FIG. 4 illustrates a process for deriving a K×K secondary transform from an N×N correlation matrix R_{N} according to an exemplary embodiment of the present invention.

Referring to FIG. 4, a correlation matrix is obtained after applying a primary transform on intra-prediction residuals in step 401. As an example, if the primary transform is DCT, then the resulting correlation matrix, denoted as U_{N}, is determined as C_{N}^{T}*R_{N}*C_{N}, where C_{N} denotes the conventional 2-d DCT matrix of size N×N and ‘*’ is the standard multiplication operator.

In step 403, the matrix for the top K rows and left-most K columns V_{K,N}=U_{N} (1:K,1:K) is obtained where the sub-scripts K and N in V_{K,N} denote that V_{K,N} is obtained from the K top rows and K left columns of N×N correlation matrix U_{N}.

In step 405, the KLT of V_{K,N} of dimension K×K denoted as W_{K,N} is determined. The resulting matrix W_{K,N} is a secondary matrix of dimension K that can be used following the DCT as a K-point transform for the first K elements of the N-point DCT output.

Finally, in step 407, in case an integer based approximation of W_{K,N} with m-bit precision (defined as Y_{K,N}) is required, W_{K,N} is multiplied by 2^{m} and then the matrix elements are rounded to the nearest integer, i.e., Y_{K,N}=round (2^{m}*W_{K,N}).

The following example illustrates derivation of an 8×8 secondary transform Y_{K,N} with 7-bit precision from R₃₂ using the process illustrated in FIG. 4. First, a DCT of size 32 is determined as:

### Columns 1 Through 10

| | | | | | | | | | |
|---|---|---|---|---|---|---|---|---|---|
| [0.1768 | 0.2497 | 0.2488 | 0.2473 | 0.2452 | 0.2425 | 0.2392 | 0.2354 | 0.2310 | 0.2260 |
| 0.1768 | 0.2473 | 0.2392 | 0.2260 | 0.2079 | 0.1852 | 0.1586 | 0.1285 | 0.0957 | 0.0607 |
| 0.1768 | 0.2425 | 0.2205 | 0.1852 | 0.1389 | 0.0842 | 0.0245 | −0.0367 | −0.0957 | −0.1489 |
| 0.1768 | 0.2354 | 0.1933 | 0.1285 | 0.0488 | −0.0367 | −0.1178 | −0.1852 | −0.2310 | −0.2497 |
| 0.1768 | 0.2260 | 0.1586 | 0.0607 | −0.0488 | −0.1489 | −0.2205 | −0.2497 | −0.2310 | −0.1679 |
| 0.1768 | 0.2144 | 0.1178 | −0.0123 | −0.1389 | −0.2260 | −0.2488 | −0.2008 | −0.0957 | 0.0367 |
| 0.1768 | 0.2008 | 0.0726 | −0.0842 | −0.2079 | −0.2497 | −0.1933 | −0.0607 | 0.0957 | 0.2144 |
| 0.1768 | 0.1852 | 0.0245 | −0.1489 | −0.2452 | −0.2144 | −0.0726 | 0.1069 | 0.2310 | 0.2354 |
| 0.1768 | 0.1679 | −0.0245 | −0.2008 | −0.2452 | −0.1285 | 0.0726 | 0.2260 | 0.2310 | 0.0842 |
| 0.1768 | 0.1489 | −0.0726 | −0.2354 | −0.2079 | −0.0123 | 0.1933 | 0.2425 | 0.0957 | −0.1285 |
| 0.1768 | 0.1285 | −0.1178 | −0.2497 | −0.1389 | 0.1069 | 0.2488 | 0.1489 | −0.0957 | −0.2473 |
| [0.1768 | 0.1069 | −0.1586 | −0.2425 | −0.0488 | 0.2008 | 0.2205 | −0.0123 | −0.2310 | −0.1852 |
| 0.1768 | 0.0842 | −0.1933 | −0.2144 | 0.0488 | 0.2473 | 0.1178 | −0.1679 | −0.2310 | 0.0123 |
| 0.1768 | 0.0607 | −0.2205 | −0.1679 | 0.1389 | 0.2354 | −0.0245 | −0.2473 | −0.0957 | 0.2008 |
| 0.1768 | 0.0367 | −0.2392 | −0.1069 | 0.2079 | 0.1679 | −0.1586 | −0.2144 | 0.0957 | 0.2425 |
| 0.1768 | 0.0123 | −0.2488 | −0.0367 | 0.2452 | 0.0607 | −0.2392 | −0.0842 | 0.2310 | 0.1069 |
| 0.1768 | −0.0123 | −0.2488 | 0.0367 | 0.2452 | −0.0607 | −0.2392 | 0.0842 | 0.2310 | −0.1069 |
| 0.1768 | −0.0367 | −0.2392 | 0.1069 | 0.2079 | −0.1679 | −0.1586 | 0.2144 | 0.0957 | −0.2425 |
| 0.1768 | −0.0607 | −0.2205 | 0.1679 | 0.1389 | −0.2354 | −0.0245 | 0.2473 | −0.0957 | −0.2008 |
| 0.1768 | −0.0842 | −0.1933 | 0.2144 | 0.0488 | −0.2473 | 0.1178 | 0.1679 | −0.2310 | −0.0123 |
| 0.1768 | −0.1069 | −0.1586 | 0.2425 | −0.0488 | −0.2008 | 0.2205 | 0.0123 | −0.2310 | 0.1852 |
| 0.1768 | −0.1285 | −0.1178 | 0.2497 | −0.1389 | −0.1069 | 0.2488 | −0.1489 | −0.0957 | 0.2473 |
| 0.1768 | −0.1489 | −0.0726 | 0.2354 | −0.2079 | 0.0123 | 0.1933 | −0.2425 | 0.0957 | 0.1285 |
| 0.1768 | −0.1679 | −0.0245 | 0.2008 | −0.2452 | 0.1285 | 0.0726 | −0.2260 | 0.2310 | −0.0842 |
| 0.1768 | −0.1852 | 0.0245 | 0.1489 | −0.2452 | 0.2144 | −0.0726 | −0.1069 | 0.2310 | −0.2354 |
| 0.1768 | −0.2008 | 0.0726 | 0.0842 | −0.2079 | 0.2497 | −0.1933 | 0.0607 | 0.0957 | −0.2144 |
| 0.1768 | −0.2144 | 0.1178 | 0.0123 | −0.1389 | 0.2260 | −0.2488 | 0.2008 | −0.0957 | −0.0367 |
| 0.1768 | −0.2260 | 0.1586 | −0.0607 | −0.0488 | 0.1489 | −0.2205 | 0.2497 | −0.2310 | 0.1679 |
| 0.1768 | −0.2354 | 0.1933 | −0.1285 | 0.0488 | 0.0367 | −0.1178 | 0.1852 | −0.2310 | 0.2497 |
| 0.1768 | −0.2425 | 0.2205 | −0.1852 | 0.1389 | −0.0842 | 0.0245 | 0.0367 | −0.0957 | 0.1489 |
| 0.1768 | −0.2473 | 0.2392 | −0.2260 | 0.2079 | −0.1852 | 0.1586 | −0.1285 | 0.0957 | −0.0607 |
| 0.1768 | −0.2497 | 0.2488 | −0.2473 | 0.2452 | −0.2425 | 0.2392 | −0.2354 | 0.2310 | −0.2260 |

### Columns 11 Through 21

| | | | | | | | | | | |
|---|---|---|---|---|---|---|---|---|---|---|
| 0.2205 | 0.2144 | 0.2079 | 0.2008 | 0.1933 | 0.1852 | 0.1768 | 0.1679 | 0.1586 | 0.1489 | 0.1389 |
| 0.0245 | −0.0123 | −0.0488 | −0.0842 | −0.1178 | −0.1489 | −0.1768 | −0.2008 | −0.2205 | −0.2354 | −0.2452 |
| −0.1933 | −0.2260 | −0.2452 | −0.2497 | −0.2392 | −0.2144 | −0.1768 | −0.1285 | −0.0726 | −0.0123 | 0.0488 |
| −0.2392 | −0.2008 | −0.1389 | −0.0607 | 0.0245 | 0.1069 | 0.1768 | 0.2260 | 0.2488 | 0.2425 | 0.2079 |
| −0.0726 | 0.0367 | 0.1389 | 0.2144 | 0.2488 | 0.2354 | 0.1768 | 0.0842 | −0.0245 | −0.1285 | −0.2079 |
| 0.1586 | 0.2354 | 0.2452 | 0.1852 | 0.0726 | −0.0607 | −0.1768 | −0.2425 | −0.2392 | −0.1679 | −0.0488 |
| 0.2488 | 0.1852 | 0.0488 | −0.1069 | −0.2205 | −0.2473 | −0.1768 | −0.0367 | 0.1178 | 0.2260 | 0.2452 |
| 0.1178 | −0.0607 | −0.2079 | −0.2473 | −0.1586 | 0.0123 | 0.1768 | 0.2497 | 0.1933 | 0.0367 | −0.1389 |
| −0.1178 | −0.2425 | −0.2079 | −0.0367 | 0.1586 | 0.2497 | 0.1768 | −0.0123 | −0.1933 | −0.2473 | −0.1389 |
| −0.2488 | −0.1679 | 0.0488 | 0.2260 | 0.2205 | 0.0367 | −0.1768 | −0.2473 | −0.1178 | 0.1069 | 0.2452 |
| −0.1586 | 0.0842 | 0.2452 | 0.1679 | −0.0726 | −0.2425 | −0.1768 | 0.0607 | 0.2392 | 0.1852 | −0.0488 |
| 0.0726 | 0.2473 | 0.1389 | −0.1285 | −0.2488 | −0.0842 | 0.1768 | 0.2354 | 0.0245 | −0.2144 | −0.2079 |
| 0.2392 | 0.1489 | −0.1389 | −0.2425 | −0.0245 | 0.2260 | 0.1768 | −0.1069 | −0.2488 | −0.0607 | 0.2079 |
| 0.1933 | −0.1069 | −0.2452 | −0.0123 | 0.2392 | 0.1285 | −0.1768 | −0.2144 | 0.0726 | 0.2497 | 0.0488 |
| −0.0245 | −0.2497 | −0.0488 | 0.2354 | 0.1178 | −0.2008 | −0.1768 | 0.1489 | 0.2205 | −0.0842 | −0.2452 |
| −0.2205 | −0.1285 | 0.2079 | 0.1489 | −0.1933 | −0.1679 | 0.1768 | 0.1852 | −0.1586 | −0.2008 | 0.1389 |
| −0.2205 | 0.1285 | 0.2079 | −0.1489 | −0.1933 | 0.1679 | 0.1768 | −0.1852 | −0.1586 | 0.2008 | 0.1389 |
| −0.0245 | 0.2497 | −0.0488 | −0.2354 | 0.1178 | 0.2008 | −0.1768 | −0.1489 | 0.2205 | 0.0842 | −0.2452 |
| 0.1933 | 0.1069 | −0.2452 | 0.0123 | 0.2392 | −0.1285 | −0.1768 | 0.2144 | 0.0726 | −0.2497 | 0.0488 |
| 0.2392 | −0.1489 | −0.1389 | 0.2425 | −0.0245 | −0.2260 | 0.1768 | 0.1069 | −0.2488 | 0.0607 | 0.2079 |
| 0.0726 | −0.2473 | 0.1389 | 0.1285 | −0.2488 | 0.0842 | 0.1768 | −0.2354 | 0.0245 | 0.2144 | −0.2079 |
| −0.1586 | −0.0842 | 0.2452 | −0.1679 | −0.0726 | 0.2425 | −0.1768 | −0.0607 | 0.2392 | −0.1852 | −0.0488 |
| −0.2488 | 0.1679 | 0.0488 | −0.2260 | 0.2205 | −0.0367 | −0.1768 | 0.2473 | −0.1178 | −0.1069 | 0.2452 |
| −0.1178 | 0.2425 | −0.2079 | 0.0367 | 0.1586 | −0.2497 | 0.1768 | 0.0123 | −0.1933 | 0.2473 | −0.1389 |
| 0.1178 | 0.0607 | −0.2079 | 0.2473 | −0.1586 | −0.0123 | 0.1768 | −0.2497 | 0.1933 | −0.0367 | −0.1389 |
| 0.2488 | −0.1852 | 0.0488 | 0.1069 | −0.2205 | 0.2473 | −0.1768 | 0.0367 | 0.1178 | −0.2260 | 0.2452 |
| 0.1586 | −0.2354 | 0.2452 | −0.1852 | 0.0726 | 0.0607 | −0.1768 | 0.2425 | −0.2392 | 0.1679 | −0.0488 |
| −0.0726 | −0.0367 | 0.1389 | −0.2144 | 0.2488 | −0.2354 | 0.1768 | −0.0842 | −0.0245 | 0.1285 | −0.2079 |
| −0.2392 | 0.2008 | −0.1389 | 0.0607 | 0.0245 | −0.1069 | 0.1768 | −0.2260 | 0.2488 | −0.2425 | 0.2079 |
| −0.1933 | 0.2260 | −0.2452 | 0.2497 | −0.2392 | 0.2144 | −0.1768 | 0.1285 | −0.0726 | 0.0123 | 0.0488 |
| 0.0245 | 0.0123 | −0.0488 | 0.0842 | −0.1178 | 0.1489 | −0.1768 | 0.2008 | −0.2205 | 0.2354 | −0.2452 |
| 0.2205 | −0.2144 | 0.2079 | −0.2008 | 0.1933 | −0.1852 | 0.1768 | −0.1679 | 0.1586 | −0.1489 | 0.1389 |

### Columns 22 Through 32

| | | | | | | | | | | |
|---|---|---|---|---|---|---|---|---|---|---|
| 0.1285 | 0.1178 | 0.1069 | 0.0957 | 0.0842 | 0.0726 | 0.0607 | 0.0488 | 0.0367 | 0.0245 | 0.0123 |
| −0.2497 | −0.2488 | −0.2425 | −0.2310 | −0.2144 | −0.1933 | −0.1679 | −0.1389 | −0.1069 | −0.0726 | −0.0367 |
| 0.1069 | 0.1586 | 0.2008 | 0.2310 | 0.2473 | 0.2488 | 0.2354 | 0.2079 | 0.1679 | 0.1178 | 0.0607 |
| 0.1489 | 0.0726 | −0.0123 | −0.0957 | −0.1679 | −0.2205 | −0.2473 | −0.2452 | −0.2144 | −0.1586 | −0.0842 |
| −0.2473 | −0.2392 | −0.1852 | −0.0957 | 0.0123 | 0.1178 | 0.2008 | 0.2452 | 0.2425 | 0.1933 | 0.1069 |
| 0.0842 | 0.1933 | 0.2473 | 0.2310 | 0.1489 | 0.0245 | −0.1069 | −0.2079 | −0.2497 | −0.2205 | −0.1285 |
| 0.1679 | 0.0245 | −0.1285 | −0.2310 | −0.2425 | −0.1586 | −0.0123 | 0.1389 | 0.2354 | 0.2392 | 0.1489 |
| −0.2425 | −0.2205 | −0.0842 | 0.0957 | 0.2260 | 0.2392 | 0.1285 | −0.0488 | −0.2008 | −0.2488 | −0.1679 |
| 0.0607 | 0.2205 | 0.2354 | 0.0957 | −0.1069 | −0.2392 | −0.2144 | −0.0488 | 0.1489 | 0.2488 | 0.1852 |
| 0.1852 | −0.0245 | −0.2144 | −0.2310 | −0.0607 | 0.1586 | 0.2497 | 0.1389 | −0.0842 | −0.2392 | −0.2008 |
| −0.2354 | −0.1933 | 0.0367 | 0.2310 | 0.2008 | −0.0245 | −0.2260 | −0.2079 | 0.0123 | 0.2205 | 0.2144 |
| 0.0367 | 0.2392 | 0.1679 | −0.0957 | −0.2497 | −0.1178 | 0.1489 | 0.2452 | 0.0607 | −0.1933 | −0.2260 |
| 0.2008 | −0.0726 | −0.2497 | −0.0957 | 0.1852 | 0.2205 | −0.0367 | −0.2452 | −0.1285 | 0.1586 | 0.2354 |
| −0.2260 | −0.1586 | 0.1489 | 0.2310 | −0.0367 | −0.2488 | −0.0842 | 0.2079 | 0.1852 | −0.1178 | −0.2425 |
| 0.0123 | 0.2488 | 0.0607 | −0.2310 | −0.1285 | 0.1933 | 0.1852 | −0.1389 | −0.2260 | 0.0726 | 0.2473 |
| 0.2144 | −0.1178 | −0.2260 | 0.0957 | 0.2354 | −0.0726 | −0.2425 | 0.0488 | 0.2473 | −0.0245 | −0.2497 |
| −0.2144 | −0.1178 | 0.2260 | 0.0957 | −0.2354 | −0.0726 | 0.2425 | 0.0488 | −0.2473 | −0.0245 | 0.2497 |
| −0.0123 | 0.2488 | −0.0607 | −0.2310 | 0.1285 | 0.1933 | −0.1852 | −0.1389 | 0.2260 | 0.0726 | −0.2473 |
| 0.2260 | −0.1586 | −0.1489 | 0.2310 | 0.0367 | −0.2488 | 0.0842 | 0.2079 | −0.1852 | −0.1178 | 0.2425 |
| −0.2008 | −0.0726 | 0.2497 | −0.0957 | −0.1852 | 0.2205 | 0.0367 | −0.2452 | 0.1285 | 0.1586 | −0.2354 |
| −0.0367 | 0.2392 | −0.1679 | −0.0957 | 0.2497 | −0.1178 | −0.1489 | 0.2452 | −0.0607 | −0.1933 | 0.2260 |
| 0.2354 | −0.1933 | −0.0367 | 0.2310 | −0.2008 | −0.0245 | 0.2260 | −0.2079 | −0.0123 | 0.2205 | −0.2144 |
| −0.1852 | −0.0245 | 0.2144 | −0.2310 | 0.0607 | 0.1586 | −0.2497 | 0.1389 | 0.0842 | −0.2392 | 0.2008 |
| −0.0607 | 0.2205 | −0.2354 | 0.0957 | 0.1069 | −0.2392 | 0.2144 | −0.0488 | −0.1489 | 0.2488 | −0.1852 |
| 0.2425 | −0.2205 | 0.0842 | 0.0957 | −0.2260 | 0.2392 | −0.1285 | −0.0488 | 0.2008 | −0.2488 | 0.1679 |
| −0.1679 | 0.0245 | 0.1285 | −0.2310 | 0.2425 | −0.1586 | 0.0123 | 0.1389 | −0.2354 | 0.2392 | −0.1489 |
| −0.0842 | 0.1933 | −0.2473 | 0.2310 | −0.1489 | 0.0245 | 0.1069 | −0.2079 | 0.2497 | −0.2205 | 0.1285 |
| 0.2473 | −0.2392 | 0.1852 | −0.0957 | −0.0123 | 0.1178 | −0.2008 | 0.2452 | −0.2425 | 0.1933 | −0.1069 |
| −0.1489 | 0.0726 | 0.0123 | −0.0957 | 0.1679 | −0.2205 | 0.2473 | −0.2452 | 0.2144 | −0.1586 | 0.0842 |
| −0.1069 | 0.1586 | −0.2008 | 0.2310 | −0.2473 | 0.2488 | −0.2354 | 0.2079 | −0.1679 | 0.1178 | −0.0607 |
| 0.2497 | −0.2488 | 0.2425 | −0.2310 | 0.2144 | −0.1933 | 0.1679 | −0.1389 | 0.1069 | −0.0726 | 0.0367 |
| −0.1285 | 0.1178 | −0.1069 | 0.0957 | −0.0842 | 0.0726 | −0.0607 | 0.0488 | −0.0367 | 0.0245 | −0.0123] |

Then, in accordance with step 401, the correlation matrix U₃₂=C₃₂^{T}*R₃₂*C₃₂, is determined as:

### Columns 1 Through 11

| | | | | | | | | | | |
|---|---|---|---|---|---|---|---|---|---|---|
| [72.6875 | −18.3337 | −4.5779 | −2.0305 | −1.1389 | −0.7261 | −0.5019 | −0.3666 | −0.2788 | −0.2185 | −0.1754 |
| −18.3337 | 12.9795 | 0.0000 | −0.0000 | 0.0000 | 0.0000 | −0.0000 | −0.0000 | 0.0000 | −0.0000 | −0.0000 |
| −4.5779 | 0.0000 | 3.2527 | 0.0000 | −0.0000 | −0.0000 | −0.0000 | −0.0000 | 0.0000 | −0.0000 | 0.0000 |
| −2.0305 | −0.0000 | 0.0000 | 1.4515 | 0.0000 | −0.0000 | 0.0000 | −0.0000 | 0.0000 | −0.0000 | −0.0000 |
| −1.1389 | 0.0000 | −0.0000 | 0.0000 | 0.8211 | 0.0000 | 0.0000 | −0.0000 | −0.0000 | −0.0000 | −0.0000 |
| −0.7261 | 0.0000 | −0.0000 | −0.0000 | 0.0000 | 0.5293 | −0.0000 | −0.0000 | 0.0000 | −0.0000 | −0.0000 |
| −0.5019 | −0.0000 | −0.0000 | 0.0000 | 0.0000 | −0.0000 | 0.3709 | −0.0000 | 0.0000 | −0.0000 | 0.0000 |
| −0.3666 | −0.0000 | −0.0000 | −0.0000 | −0.0000 | −0.0000 | −0.0000 | 0.2753 | 0.0000 | −0.0000 | −0.0000 |
| −0.2788 | 0.0000 | 0.0000 | 0.0000 | −0.0000 | 0.0000 | 0.0000 | 0.0000 | 0.2134 | −0.0000 | −0.0000 |
| −0.2185 | −0.0000 | −0.0000 | −0.0000 | −0.0000 | −0.0000 | −0.0000 | −0.0000 | −0.0000 | 0.1709 | −0.0000 |
| −0.1754 | −0.0000 | 0.0000 | −0.0000 | −0.0000 | −0.0000 | 0.0000 | −0.0000 | −0.0000 | −0.0000 | 0.1406 |
| −0.1434 | −0.0000 | 0.0000 | −0.0000 | −0.0000 | −0.0000 | 0.0000 | −0.0000 | −0.0000 | −0.0000 | −0.0000 |
| −0.1191 | −0.0000 | 0.0000 | 0.0000 | −0.0000 | 0.0000 | −0.0000 | −0.0000 | −0.0000 | −0.0000 | −0.0000 |
| −0.1000 | −0.0000 | −0.0000 | −0.0000 | −0.0000 | −0.0000 | −0.0000 | −0.0000 | −0.0000 | −0.0000 | −0.0000 |
| −0.0849 | 0.0000 | 0.0000 | 0.0000 | 0.0000 | 0.0000 | −0.0000 | 0.0000 | 0.0000 | 0.0000 | −0.0000 |
| −0.0726 | −0.0000 | 0.0000 | −0.0000 | 0.0000 | −0.0000 | −0.0000 | −0.0000 | −0.0000 | −0.0000 | 0.0000 |
| −0.0625 | −0.0000 | −0.0000 | −0.0000 | −0.0000 | −0.0000 | −0.0000 | −0.0000 | −0.0000 | −0.0000 | −0.0000 |
| −0.0541 | 0.0000 | −0.0000 | 0.0000 | −0.0000 | 0.0000 | 0.0000 | −0.0000 | 0.0000 | −0.0000 | 0.0000 |
| −0.0469 | −0.0000 | −0.0000 | −0.0000 | −0.0000 | −0.0000 | −0.0000 | −0.0000 | −0.0000 | −0.0000 | −0.0000 |
| −0.0408 | −0.0000 | −0.0000 | −0.0000 | 0.0000 | −0.0000 | 0.0000 | −0.0000 | −0.0000 | −0.0000 | −0.0000 |
| −0.0355 | −0.0000 | −0.0000 | −0.0000 | −0.0000 | −0.0000 | −0.0000 | −0.0000 | −0.0000 | −0.0000 | −0.0000 |
| −0.0309 | −0.0000 | −0.0000 | −0.0000 | 0.0000 | −0.0000 | −0.0000 | −0.0000 | 0.0000 | −0.0000 | −0.0000 |
| −0.0268 | 0.0000 | −0.0000 | 0.0000 | 0.0000 | 0.0000 | −0.0000 | 0.0000 | −0.0000 | 0.0000 | −0.0000 |
| −0.0231 | 0.0000 | −0.0000 | 0.0000 | 0.0000 | 0.0000 | −0.0000 | 0.0000 | 0.0000 | 0.0000 | 0.0000 |
| −0.0198 | −0.0000 | 0.0000 | −0.0000 | 0.0000 | 0.0000 | 0.0000 | 0.0000 | −0.0000 | 0.0000 | 0.0000 |
| −0.0168 | 0.0000 | 0.0000 | 0.0000 | −0.0000 | −0.0000 | 0.0000 | −0.0000 | 0.0000 | 0.0000 | −0.0000 |
| −0.0140 | 0.0000 | −0.0000 | 0.0000 | 0.0000 | −0.0000 | 0.0000 | −0.0000 | 0.0000 | 0.0000 | −0.0000 |
| −0.0114 | −0.0000 | −0.0000 | −0.0000 | −0.0000 | −0.0000 | −0.0000 | −0.0000 | −0.0000 | −0.0000 | −0.0000 |
| −0.0090 | −0.0000 | −0.0000 | 0.0000 | −0.0000 | 0.0000 | −0.0000 | 0.0000 | −0.0000 | −0.0000 | 0.0000 |
| −0.0066 | −0.0000 | −0.0000 | −0.0000 | −0.0000 | −0.0000 | 0.0000 | −0.0000 | 0.0000 | −0.0000 | −0.0000 |
| −0.0044 | −0.0000 | −0.0000 | −0.0000 | −0.0000 | 0.0000 | −0.0000 | 0.0000 | −0.0000 | −0.0000 | −0.0000 |
| −0.0022 | 0.0000 | 0.0000 | 0.0000 | 0.0000 | 0.0000 | 0.0000 | 0.0000 | 0.0000 | 0.0000 | 0.0000 |

### Columns 12 Through 22

| | | | | | | | | | | |
|---|---|---|---|---|---|---|---|---|---|---|
| −0.1434 | −0.1191 | −0.1000 | −0.0849 | −0.0726 | −0.0625 | −0.0541 | −0.0469 | −0.0408 | −0.0355 | −0.0309 |
| −0.0000 | −0.0000 | −0.0000 | 0.0000 | −0.0000 | −0.0000 | 0.0000 | −0.0000 | −0.0000 | −0.0000 | −0.0000 |
| 0.0000 | 0.0000 | −0.0000 | 0.0000 | 0.0000 | −0.0000 | −0.0000 | −0.0000 | −0.0000 | −0.0000 | −0.0000 |
| −0.0000 | 0.0000 | −0.0000 | 0.0000 | −0.0000 | −0.0000 | 0.0000 | −0.0000 | −0.0000 | −0.0000 | −0.0000 |
| −0.0000 | −0.0000 | −0.0000 | 0.0000 | 0.0000 | −0.0000 | −0.0000 | −0.0000 | 0.0000 | −0.0000 | 0.0000 |
| −0.0000 | 0.0000 | −0.0000 | 0.0000 | −0.0000 | −0.0000 | 0.0000 | −0.0000 | −0.0000 | −0.0000 | −0.0000 |
| 0.0000 | −0.0000 | −0.0000 | −0.0000 | −0.0000 | −0.0000 | 0.0000 | −0.0000 | 0.0000 | −0.0000 | −0.0000 |
| −0.0000 | −0.0000 | −0.0000 | 0.0000 | −0.0000 | −0.0000 | −0.0000 | −0.0000 | −0.0000 | −0.0000 | −0.0000 |
| −0.0000 | −0.0000 | −0.0000 | 0.0000 | −0.0000 | −0.0000 | 0.0000 | −0.0000 | −0.0000 | 0.0000 | 0.0000 |
| −0.0000 | −0.0000 | −0.0000 | 0.0000 | −0.0000 | −0.0000 | −0.0000 | −0.0000 | −0.0000 | −0.0000 | −0.0000 |
| −0.0000 | −0.0000 | −0.0000 | −0.0000 | 0.0000 | −0.0000 | 0.0000 | −0.0000 | −0.0000 | −0.0000 | −0.0000 |
| 0.1182 | 0.0000 | −0.0000 | 0.0000 | −0.0000 | −0.0000 | −0.0000 | −0.0000 | −0.0000 | −0.0000 | −0.0000 |
| 0.0000 | 0.1012 | −0.0000 | 0.0000 | −0.0000 | −0.0000 | −0.0000 | −0.0000 | −0.0000 | 0.0000 | −0.0000 |
| −0.0000 | −0.0000 | 0.0881 | −0.0000 | −0.0000 | −0.0000 | −0.0000 | −0.0000 | −0.0000 | −0.0000 | −0.0000 |
| 0.0000 | 0.0000 | −0.0000 | 0.0776 | 0.0000 | −0.0000 | 0.0000 | −0.0000 | −0.0000 | −0.0000 | 0.0000 |
| −0.0000 | −0.0000 | −0.0000 | 0.0000 | 0.0693 | −0.0000 | −0.0000 | −0.0000 | −0.0000 | −0.0000 | −0.0000 |
| −0.0000 | −0.0000 | −0.0000 | −0.0000 | −0.0000 | 0.0625 | −0.0000 | −0.0000 | −0.0000 | −0.0000 | −0.0000 |
| −0.0000 | −0.0000 | −0.0000 | 0.0000 | −0.0000 | −0.0000 | 0.0569 | −0.0000 | −0.0000 | −0.0000 | −0.0000 |
| −0.0000 | −0.0000 | −0.0000 | −0.0000 | −0.0000 | −0.0000 | −0.0000 | 0.0523 | −0.0000 | −0.0000 | −0.0000 |
| −0.0000 | −0.0000 | −0.0000 | −0.0000 | −0.0000 | −0.0000 | −0.0000 | −0.0000 | 0.0484 | 0.0000 | −0.0000 |
| −0.0000 | 0.0000 | −0.0000 | −0.0000 | −0.0000 | −0.0000 | −0.0000 | −0.0000 | 0.0000 | 0.0452 | 0.0000 |
| −0.0000 | −0.0000 | −0.0000 | 0.0000 | −0.0000 | −0.0000 | −0.0000 | −0.0000 | −0.0000 | 0.0000 | 0.0425 |
| 0.0000 | −0.0000 | 0.0000 | −0.0000 | 0.0000 | −0.0000 | 0.0000 | −0.0000 | 0.0000 | 0.0000 | −0.0000 |
| 0.0000 | 0.0000 | 0.0000 | 0.0000 | 0.0000 | −0.0000 | 0.0000 | −0.0000 | 0.0000 | 0.0000 | 0.0000 |
| −0.0000 | 0.0000 | −0.0000 | 0.0000 | −0.0000 | −0.0000 | 0.0000 | 0.0000 | 0.0000 | −0.0000 | 0.0000 |
| 0.0000 | −0.0000 | 0.0000 | 0.0000 | 0.0000 | 0.0000 | 0.0000 | 0.0000 | −0.0000 | 0.0000 | −0.0000 |
| 0.0000 | −0.0000 | 0.0000 | −0.0000 | 0.0000 | 0.0000 | −0.0000 | 0.0000 | −0.0000 | 0.0000 | −0.0000 |
| −0.0000 | −0.0000 | −0.0000 | −0.0000 | −0.0000 | −0.0000 | −0.0000 | −0.0000 | −0.0000 | −0.0000 | −0.0000 |
| 0.0000 | −0.0000 | 0.0000 | −0.0000 | 0.0000 | −0.0000 | −0.0000 | 0.0000 | −0.0000 | 0.0000 | −0.0000 |
| −0.0000 | −0.0000 | −0.0000 | 0.0000 | −0.0000 | −0.0000 | −0.0000 | 0.0000 | −0.0000 | −0.0000 | −0.0000 |
| −0.0000 | −0.0000 | −0.0000 | −0.0000 | −0.0000 | −0.0000 | 0.0000 | −0.0000 | 0.0000 | −0.0000 | 0.0000 |
| 0.0000 | 0.0000 | 0.0000 | 0.0000 | 0.0000 | 0.0000 | 0.0000 | 0.0000 | 0.0000 | 0.0000 | 0.0000 |

### Columns 23 Through 32

| | | | | | | | | | |
|---|---|---|---|---|---|---|---|---|---|
| −0.0268 | −0.0231 | −0.0198 | −0.0168 | −0.0140 | −0.0114 | −0.0090 | −0.0066 | −0.0044 | −0.0022 |
| 0.0000 | 0.0000 | −0.0000 | 0.0000 | 0.0000 | −0.0000 | −0.0000 | −0.0000 | −0.0000 | 0.0000 |
| −0.0000 | −0.0000 | 0.0000 | 0.0000 | −0.0000 | −0.0000 | −0.0000 | −0.0000 | −0.0000 | 0.0000 |
| 0.0000 | 0.0000 | −0.0000 | 0.0000 | 0.0000 | −0.0000 | 0.0000 | −0.0000 | −0.0000 | 0.0000 |
| 0.0000 | 0.0000 | 0.0000 | −0.0000 | 0.0000 | −0.0000 | −0.0000 | −0.0000 | −0.0000 | 0.0000 |
| 0.0000 | 0.0000 | −0.0000 | −0.0000 | −0.0000 | −0.0000 | 0.0000 | −0.0000 | 0.0000 | 0.0000 |
| −0.0000 | −0.0000 | 0.0000 | 0.0000 | 0.0000 | −0.0000 | −0.0000 | 0.0000 | −0.0000 | 0.0000 |
| 0.0000 | 0.0000 | 0.0000 | −0.0000 | −0.0000 | −0.0000 | 0.0000 | −0.0000 | 0.0000 | 0.0000 |
| −0.0000 | 0.0000 | −0.0000 | 0.0000 | 0.0000 | −0.0000 | −0.0000 | 0.0000 | −0.0000 | 0.0000 |
| 0.0000 | 0.0000 | 0.0000 | 0.0000 | 0.0000 | −0.0000 | −0.0000 | −0.0000 | −0.0000 | 0.0000 |
| −0.0000 | 0.0000 | 0.0000 | −0.0000 | −0.0000 | −0.0000 | 0.0000 | −0.0000 | −0.0000 | 0.0000 |
| 0.0000 | 0.0000 | −0.0000 | 0.0000 | 0.0000 | −0.0000 | 0.0000 | −0.0000 | −0.0000 | 0.0000 |
| −0.0000 | 0.0000 | 0.0000 | −0.0000 | −0.0000 | −0.0000 | −0.0000 | −0.0000 | −0.0000 | 0.0000 |
| 0.0000 | 0.0000 | −0.0000 | 0.0000 | 0.0000 | −0.0000 | 0.0000 | −0.0000 | −0.0000 | 0.0000 |
| −0.0000 | 0.0000 | 0.0000 | 0.0000 | −0.0000 | −0.0000 | −0.0000 | 0.0000 | −0.0000 | 0.0000 |
| 0.0000 | 0.0000 | −0.0000 | 0.0000 | 0.0000 | −0.0000 | 0.0000 | −0.0000 | −0.0000 | 0.0000 |
| −0.0000 | −0.0000 | −0.0000 | 0.0000 | 0.0000 | −0.0000 | −0.0000 | −0.0000 | −0.0000 | 0.0000 |
| 0.0000 | 0.0000 | 0.0000 | 0.0000 | −0.0000 | −0.0000 | −0.0000 | −0.0000 | 0.0000 | 0.0000 |
| −0.0000 | −0.0000 | 0.0000 | 0.0000 | 0.0000 | −0.0000 | 0.0000 | 0.0000 | −0.0000 | 0.0000 |
| 0.0000 | 0.0000 | 0.0000 | −0.0000 | −0.0000 | −0.0000 | −0.0000 | −0.0000 | 0.0000 | 0.0000 |
| 0.0000 | 0.0000 | −0.0000 | 0.0000 | 0.0000 | −0.0000 | 0.0000 | −0.0000 | −0.0000 | 0.0000 |
| −0.0000 | 0.0000 | 0.0000 | −0.0000 | −0.0000 | −0.0000 | −0.0000 | −0.0000 | 0.0000 | 0.0000 |
| 0.0402 | 0.0000 | −0.0000 | 0.0000 | −0.0000 | −0.0000 | −0.0000 | 0.0000 | −0.0000 | 0.0000 |
| 0.0000 | 0.0382 | 0.0000 | −0.0000 | 0.0000 | −0.0000 | 0.0000 | −0.0000 | 0.0000 | 0.0000 |
| −0.0000 | 0.0000 | 0.0366 | 0.0000 | −0.0000 | −0.0000 | 0.0000 | 0.0000 | 0.0000 | 0.0000 |
| 0.0000 | −0.0000 | 0.0000 | 0.0353 | 0.0000 | −0.0000 | −0.0000 | −0.0000 | 0.0000 | 0.0000 |
| −0.0000 | 0.0000 | −0.0000 | 0.0000 | 0.0341 | 0.0000 | 0.0000 | 0.0000 | −0.0000 | 0.0000 |
| −0.0000 | −0.0000 | −0.0000 | −0.0000 | 0.0000 | 0.0332 | −0.0000 | −0.0000 | −0.0000 | 0.0000 |
| −0.0000 | 0.0000 | 0.0000 | −0.0000 | 0.0000 | −0.0000 | 0.0325 | 0.0000 | −0.0000 | 0.0000 |
| 0.0000 | −0.0000 | 0.0000 | −0.0000 | 0.0000 | −0.0000 | 0.0000 | 0.0319 | 0.0000 | −0.0000 |
| −0.0000 | 0.0000 | 0.0000 | 0.0000 | −0.0000 | −0.0000 | −0.0000 | 0.0000 | 0.0316 | 0.0000 |
| 0.0000 | 0.0000 | 0.0000 | 0.0000 | 0.0000 | 0.0000 | 0.0000 | −0.0000 | 0.0000 | 0.0313] |

Next, per step 403, V_{8,32} is obtained as the top 8×8 portion of the matrix U₃₂, i.e., V_{8,32}=U₃₂ (1:8,1:8), which is determined as:

| | | | | | | | |
|---|---|---|---|---|---|---|---|
| [72.6875 | −18.3337 | −4.5779 | −2.0305 | −1.1389 | −0.7261 | −0.5019 | −0.3666 |
| −18.3337 | 12.9795 | 0.0000 | −0.0000 | 0.0000 | 0.0000 | −0.0000 | −0.0000 |
| −4.5779 | 0.0000 | 3.2527 | 0.0000 | −0.0000 | −0.0000 | −0.0000 | −0.0000 |
| −2.0305 | −0.0000 | 0.0000 | 1.4515 | 0.0000 | −0.0000 | 0.0000 | −0.0000 |
| −1.1389 | 0.0000 | −0.0000 | 0.0000 | 0.8211 | 0.0000 | 0.0000 | −0.0000 |
| −0.7261 | 0.0000 | −0.0000 | −0.0000 | 0.0000 | 0.5293 | −0.0000 | −0.0000 |
| −0.5019 | −0.0000 | −0.0000 | 0.0000 | 0.0000 | −0.0000 | 0.3709 | −0.0000 |
| −0.3666 | −0.0000 | −0.0000 | −0.0000 | −0.0000 | −0.0000 | −0.0000 | 0.2753] |

In accordance with step 405, the KLT of V_{8,32}, (i.e., W_{8,32}=KLT (V_{8,32}), is determined as:

$$\begin{matrix}[ 0.9606 & 0.2465 & - 0.1061 & 0.0564 & - 0.0343 & 0.0229 & - 0.0165 & 0.0128 \\ - 0.2700 & 0.9372 & - 0.1901 & 0.0887 & - 0.0516 & 0.0337 & - 0.0240 & 0.0185 \\ - 0.0587 & - 0.2300 & - 0.9586 & 0.1345 & - 0.0635 & 0.0383 & - 0.0261 & 0.0196 \\ - 0.0254 & - 0.0746 & 0.1665 & 0.9754 & - 0.1039 & 0.0496 & - 0.0308 & 0.0220 \\ - 0.0141 & - 0.0383 & 0.0628 & - 0.1251 & - 0.9845 & 0.0847 & - 0.0410 & 0.0265 \\ - 0.0090 & - 0.0235 & 0.0348 & - 0.0509 & 0.0988 & 0.9896 & - 0.0718 & 0.0359 \\ - 0.0062 & - 0.0159 & 0.0224 & - 0.0294 & 0.0419 & - 0.0813 & - 0.9929 & 0.0641 \\ - 0.0045 & - 0.0115 & 0.0157 & - 0.0195 & 0.0248 & - 0.0355 & 0.0694 & 0.9963 ]\end{matrix}$$

Finally, for the integer approximation of step 407, multiplication is made by 2⁷=128, and the resulting elements are rounded in the matrix Y_{8,32}=round (128*W_{8,32}), which is determined as:

$$\begin{matrix}[ 123 & - 35 & - 8 & - 3 & - 2 & - 1 & - 1 & - 1 \\ 32 & 120 & - 29 & - 10 & - 5 & - 3 & - 2 & - 1 \\ - 14 & - 24 & - 123 & 21 & 8 & 4 & 3 & 2 \\ 7 & 11 & 17 & 125 & - 16 & - 7 & - 4 & - 2 \\ - 4 & - 7 & - 8 & - 13 & - 126 & 13 & 5 & 3 \\ 3 & 4 & 5 & 6 & 11 & 127 & - 10 & - 5 \\ - 2 & - 3 & - 3 & - 4 & - 5 & - 9 & - 127 & 9 \\ 2 & 2 & 3 & 3 & 3 & 5 & 8 & 128 ]\end{matrix}$$

where the basis vectors are along the rows in Y_{8,32}.

The following examples illustrate determinations of secondary 2×2 to 7×7 matrices obtained from the original 32×32 matrix in accordance with the procedure of FIG. 4.

### 2×2 Secondary Transform:

V_{2,32}=U₃₂ (1:2,1:2) is determined as:

$$\begin{matrix}[ 72.6875 & - 18.3337 \\ - 18.3337 & 12.9795 ]\end{matrix}$$

The KLT of V_{2,32} (i.e., W_{2,32}=KLT (V_{2,32})) is determined as:

$$\begin{matrix}[ 0.9623 & 0.2719 \\ - 0.2719 & 0.9623 ]\end{matrix}$$

For the integer approximation, multiplication is made by 2⁷=128, and the resulting elements are rounded in the matrix Y_{2,32}=round (128*W_{2,32}), which is determined as:

$$\begin{matrix}[ 123 & - 35 \\ 35 & 123 ]\end{matrix}$$

### 3×3 Secondary Transform:

V_{3,32}=(U₃₂ 1:3,1:3) is determined as:

$$\begin{matrix}[ 72.6875 & - 18.3337 & - 4.5779 \\ - 18.3337 & 12.9795 & 0.0000 \\ - 4.5779 & 0.0000 & 3.2527 ]\end{matrix}$$

The KLT of V_{3,32} (i.e., W_{3,32}=KLT (V_{3,32})) is determined as:

$$\begin{matrix}[ 0.9609 & - 0.2499 & 0.1190 \\ - 0.2704 & - 0.9391 & 0.2120 \\ - 0.0588 & 0.2359 & 0.9700 ]\end{matrix}$$

For the integer approximation, multiplication is made by 2⁷=128, and the resulting elements are rounded in the matrix Y_{3,32}=round (128*W_{3,32}), which is determined as:

$$\begin{matrix}[ 123 & - 35 & - 8 \\ - 32 & - 120 & 30 \\ 15 & 27 & 124 ]\end{matrix}$$

### 4×4 Secondary Transform:

V_{4,32}=U₃₂ (1:4,1:4) is determined as:

$$\begin{matrix}[ 72.6875 & - 18.3337 & - 4.5779 & - 2.0305 \\ - 18.3337 & 12.9795 & 0.0000 & - 0.0000 \\ - 4.5779 & 0.0000 & 3.2527 & 0.0000 \\ - 2.0305 & - 0.0000 & 0.0000 & 1.4515 ]\end{matrix}$$

The KLT of V_{4,32} (i.e., W_{4,32}=KLT (V_{4,32})) is determined as:

$$\begin{matrix}[ 0.9607 & - 0.2475 & 0.1088 & 0.0629 \\ - 0.2702 & - 0.9377 & 0.1947 & 0.0990 \\ - 0.0587 & 0.2319 & 0.9595 & 0.1491 \\ - 0.0254 & 0.0751 & - 0.1723 & 0.9818 ]\end{matrix}$$

For the integer approximation, multiplication is made by 2⁷=128, and the resulting elements are rounded in the matrix Y_{4,32}=round (128*W_{4,32}), which is determined as:

$$\begin{matrix}[ 123 & - 35 & - 8 & - 3 \\ - 32 & - 120 & 30 & 10 \\ 14 & 25 & 123 & - 22 \\ 8 & 13 & 19 & 126 ]\end{matrix}$$

### 5×5 Secondary Transform:

V_{5,32}=U₃₂ (1:5,1:5) is determined as:

$$\begin{matrix}[ 72.6875 & - 18.3337 & - 4.5779 & - 2.0305 & - 1.1389 \\ - 18.3337 & 12.9795 & 0.0000 & - 0.0000 & 0.0000 \\ - 4.5779 & 0.0000 & 3.2527 & 0.0000 & - 0.0000 \\ - 2.0305 & - 0.0000 & 0.0000 & 1.4515 & 0.0000 \\ - 1.1389 & 0.0000 & - 0.0000 & 0.0000 & 0.8211 ]\end{matrix}$$

The KLT of V_{5,32} (i.e., W_{5,32}=KLT (V_{5,32})) is determined as:

$$\begin{matrix}[ - 0.9606 & 0.2469 & - 0.1071 & 0.0580 & 0.0378 \\ 0.2701 & 0.9374 & - 0.1918 & 0.0913 & 0.0568 \\ 0.0587 & - 0.2308 & - 0.9588 & 0.1382 & 0.0699 \\ 0.0254 & - 0.0748 & 0.1686 & 0.9759 & 0.1139 \\ 0.0141 & - 0.0384 & 0.0635 & - 0.1297 & 0.9887 ]\end{matrix}$$

For the integer approximation, multiplication is made by 2⁷=128, and the resulting elements are rounded in the matrix Y_{5,32}=round (128*W_{5,32}), which is determined as:

$$\begin{matrix}[ - 123 & 35 & 8 & 3 & 2 \\ 32 & 120 & - 30 & - 10 & - 5 \\ - 14 & - 25 & - 123 & 22 & 8 \\ 7 & 12 & 18 & 125 & - 17 \\ 5 & 7 & 9 & 15 & 127 ]\end{matrix}$$

### 6×6 Secondary Transform:

V_{6,32}=U₃₂ (1:6,1:6) is determined as:

$$\begin{matrix}[ 72.6875 & - 18.3337 & - 4.5779 & - 2.0305 & - 1.1389 & - 0.7261 \\ - 18.3337 & 12.9795 & 0.0000 & - 0.0000 & 0.0000 & 0.0000 \\ - 4.5779 & 0.0000 & 3.2527 & 0.0000 & - 0.0000 & - 0.0000 \\ - 2.0305 & - 0.0000 & 0.0000 & 1.4515 & 0.0000 & - 0.0000 \\ - 1.1389 & 0.0000 & - 0.0000 & 0.0000 & 0.8211 & 0.0000 \\ - 0.7261 & 0.0000 & - 0.0000 & - 0.0000 & 0.0000 & 0.5293 ]\end{matrix}$$

The KLT of V_{6,32} (i.e., W_{6,32}=KLT (V_{6,32})) is determined as:

$$\begin{matrix}[ 0.9606 & 0.2467 & - 0.1065 & 0.0570 & 0.0352 & 0.0248 \\ - 0.2700 & 0.9373 & - 0.1908 & 0.0897 & 0.0529 & 0.0365 \\ - 0.0587 & - 0.2303 & - 0.9587 & 0.1358 & 0.0652 & 0.0415 \\ - 0.0254 & - 0.0747 & 0.1673 & 0.9755 & 0.1066 & 0.0537 \\ - 0.0141 & - 0.0383 & 0.0631 & - 0.1268 & 0.9849 & 0.0913 \\ - 0.0090 & - 0.0235 & 0.0349 & - 0.0515 & - 0.1019 & 0.9925 ]\end{matrix}$$

For the integer approximation, multiplication is made by 2⁷=128, and the resulting elements are rounded in the matrix Y_{6,32}=round (128*W_{6,32}), which is determined as:

$$\begin{matrix}[ 123 & - 35 & - 8 & - 3 & - 2 & - 1 \\ 32 & 120 & - 29 & - 10 & - 5 & - 3 \\ - 14 & - 24 & - 123 & 21 & 8 & 4 \\ 7 & 11 & 17 & 125 & - 16 & - 7 \\ 5 & 7 & 8 & 14 & 126 & - 13 \\ 3 & 5 & 5 & 7 & 12 & 127 ]\end{matrix}$$

### 7×7 Secondary Transform:

V_{7,32}=U₃₂ (1:7,1:7) is determined as:

$$\begin{matrix}[ 72.6875 & - 18.3337` & - 4.5779 & - 2.0305` & - 1.1389` & - 0.7261 & - 0.5019 \\ - 18.3337 & 12.9795 & 0.0000 & - 0.0000 & 0.0000 & 0.0000 & - 0.0000 \\ - 4.5779 & 0.0000 & 3.2527 & 0.0000 & - 0.0000 & - 0.0000 & - 0.0000 \\ - 2.0305 & - 0.0000 & 0.0000 & 1.4515 & 0.0000 & - 0.0000 & 0.0000 \\ - 1.1389 & 0.0000 & - 0.0000 & 0.0000 & 0.8211 & 0.0000 & 0.0000 \\ - 0.7261 & 0.0000 & - 0.0000 & - 0.0000 & 0.0000 & 0.5293 & - 0.0000 \\ - 0.5019 & - 0.0000 & - 0.0000 & 0.0000 & 0.0000 & - 0.0000 & 0.3709 ]\end{matrix}$$

The KLT of V7,32 (i.e., W7,32=KLT (V7,32)) is determined as:

$$\begin{matrix}[ 0.9606 & - 0.2465 & 0.1063 & - 0.0566 & 0.0346 & - 0.0234 & 0.0174 \\ - 0.2700 & - 0.9372 & 0.1903 & - 0.0890 & 0.0520 & - 0.0344 & 0.0253 \\ - 0.0587 & 0.2301 & 0.9586 & - 0.1349 & 0.0640 & - 0.0390 & 0.0276 \\ - 0.0254 & 0.0747 & - 0.1667 & - 0.9754 & 0.1047 & - 0.0505 & 0.0325 \\ - 0.0141 & 0.0383 & - 0.0629 & 0.1256 & 0.9845 & - 0.0861 & 0.0432 \\ - 0.0090 & 0.0235 & - 0.0348 & 0.0511 & - 0.0997 & - 0.9899 & 0.0756 ] \\ - 0.0062 & 0.0159 & - 0.0225 & 0.0295 & - 0.0423 & 0.0830 & 0.9948 ]\end{matrix}$$

For the integer approximation, multiplication is made by 2⁷=128, and the resulting elements are rounded in the matrix Y_{7,32}=round (128*W_{7,32}), which is determined as:

$$[ \begin{matrix}123 & - 35 & - 8 & - 3 & - 2 & - 1 & - 1 \\ - 32 & - 120 & 29 & 10 & 5 & 3 & 2 \\ 14 & 24 & 123 & - 21 & - 8 & - 4 & - 3 \\ - 7 & - 11 & - 17 & - 125 & 16 & 7 & 4 \\ 4 & 7 & 8 & 13 & 126 & - 13 & - 5 \\ - 3 & - 4 & - 5 & - 6 & - 11 & - 127 & 11 \\ 2 & 3 & 4 & 4 & 6 & 10 & 127\end{matrix} ]$$

It is noted that the above process can be extended in a straightforward fashion for the derivation of any K×K secondary transform from an N×N correlation matrix R_{N}.

Finally, it is noted that a K×K secondary transform can be applied to block sizes other than N×N. For example, an 8×8 secondary transform designed for 32×32 input can also be applied as the secondary transform on 8×8 and 16×16 square blocks, as well as rectangular blocks such as 8×16, 16×8, 8×32, 32×8 etc. The advantage of using an 8×8 secondary transform Y_{8,32} designed using 32×32 to other block sizes would be that no additional transform would be used (such as Y_{8,16}: 8×8 secondary matrix designed using 16×16 correlation matrix, etc.).

1.7 Secondary Transform from a Combination of Two Correlation Matrices:

It is noted that the above procedure would yield an optimal secondary transform for the first K-points of N-point input data. For example, Y_{8,8}, Y_{8,16} and Y_{8,32} would respectively be the optimal 8×8 transforms for V_{8,8}, V_{8,16} and V_{8,32}, i.e., the top 8 rows, and leftmost 8 columns of the original correlation matrices U₈=C₈^{T}*R₈*C₈, U₁₆=C₁₆^{T}*R₁₆*C₁₆ and U₃₂=C₃₂^{T}*R₃₂*C₃₂ respectively.

However, if it is necessary to design one matrix for all the correlation matrices of sizes 8×8, 16×16 and 32×32, a probabilistic distribution must be assumed when the input would be 8-point (i.e., corresponding to an 8×8 correlation matrix U₈), 16-point, or 32-point. In the following analysis, p₈, p₁₆, and p₃₂ respectively denote the probability of an input being 8-point, 16-point and 32-point. Of course, this is only for illustration and the input can be any N-point, where N is an integer greater than or equal to K.

Obtaining a new correlation matrix (for the example case of input being either 8-point, 16-point or 32-point) would include using Equation (3) to determine V_{8,Avg}.

V_{8,Avg}=p₈V_{8,8,Normalized}+p₁₆V_{8,16,Normalized}+p₃₂V_{8,32,Normalized} Equation (3)

In Equation (3), V_{8,8,Normalized}=(⅛) V_{8,8}, V_{8,16,Normalized}=( 1/16) V_{8,16}, and V_{8,32,Normalized}=( 1/32) V_{8,32}. Note that the (⅛) factor for normalizing V_{8,8} is due to the normalization coming from an 8×8 DCT. In general, an N×N DCT C_{N} has a sqrt (1/N) factor in it, and, after multiplying by the correlation matrix R_{N} of size N×N, N elements are added. This implies that the resulting coefficients of the matrix R_{N}*C_{N} have a factor of sqrt(1/N)*N=sqrt(N) in the numerator which requires normalization. Hence, it is necessary to divide the matrix R_{N}*C_{N} appropriately by sqrt (N). If the multiplication is performed from the left as well, an additional division by sqrt (N) is necessary, or equivalently for C_{N}^{T}*R_{N}*C_{N}, division by a factor of 1/N is necessary.

In the general case, V_{K,Avg} can be given by Equation (4):

$${V}_{K , Avg} = {\sum }_{i} {p}_{i} {V}_{K , i , Normalized} \qquad Equation ( 4 )$$

where the secondary transform is applied on the first K-points, ‘i’ is the running index for the i-point input distribution with probability pᵢ, V_{K,i,Normalized}=(1/i) V_{K,i}=(1/i) Uᵢ (1:K,1:K), Uᵢ=Cᵢ^{T}*Rᵢ*Cᵢ; Rᵢ is the correlation for i-point input, and Cᵢ is the 2-d i×i DCT matrix.

After the computation of V_{K,Avg}, the single secondary matrix can be determined as W_{K,Avg}=KLT (V_{K,Avg}). For the integer approximation with m-bit precision, multiplication can be made by 2^{m}, and then rounding of the resulting elements in the matrix Y_{K,Avg}=round (2^{m}*W_{K,Avg}) can be performed.

### 1.8 Application of Secondary Transform Based on Intra-Prediction Modes

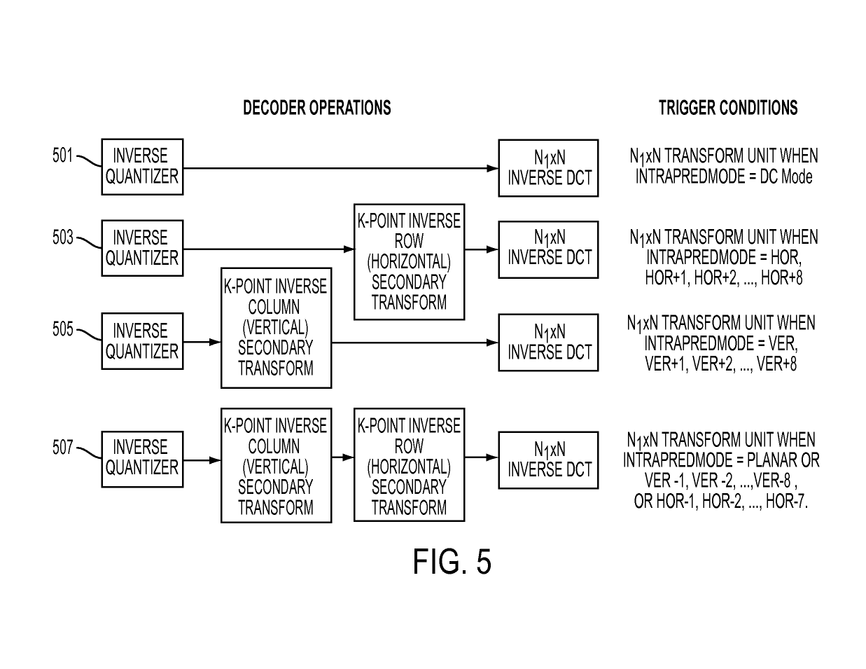

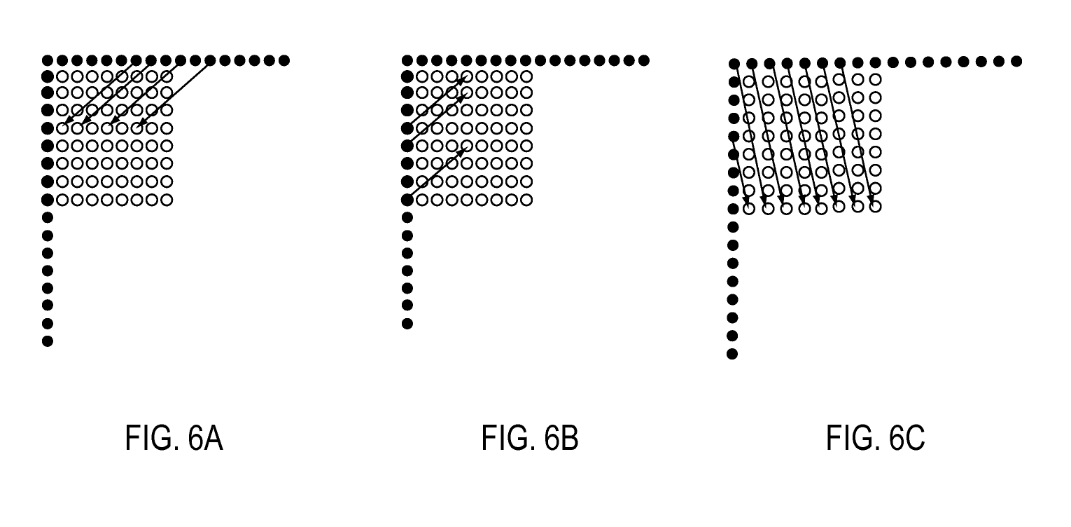

FIG. 5 illustrates decoder operations for mode-dependent secondary transforms according to an exemplary embodiment of the present invention. FIGS. 6A-6C illustrate different categories of prediction modes according to exemplary embodiments of the present invention.

Referring to FIG. 5, decoder operations 501, 503, 505, and 507 are illustrated when a K-point mode-dependent secondary transform is applied as a row or column transform depending on the intra prediction mode for a rectangular block of size N₁×N. It is noted that N₁ and N are greater than or equal to K, and N₁ and N can be equal (i.e., a square block). The trigger conditions when the secondary transform is used are shown in the right column of FIG. 5 and depend on the categorization of the intra prediction modes.

Referring to FIGS. 6A and 6B, if the prediction for a block is performed from only one of the top row or left column, the prediction mode is termed a Category 1 intra prediction mode. Referring to FIG. 6C. in case the prediction for the block is performed from both the top row and left columns, it is termed a Category 2 prediction mode.

As illustrated in FIG. 5, when the intra prediction mode is a DC mode (i.e., a non-directional mode), decoder operation 501 is performed and no secondary transform is applied in the horizontal and vertical directions. For category 1 intra prediction modes, if the prediction was performed from pixels only from the left column (i.e., in horizontal direction) and the intra prediction modes are one of HOR, HOR+1, HOR+2, . . . HOR+8, then decoder operation 503 is performed and the secondary transform is used only in the horizontal direction (i.e., along rows). In case, the prediction was performed from pixels only from the top row (i.e., in vertical direction) and intra prediction modes are VER, VER+1, VER+2, . . . VER+8, then decoder operation 505 is performed and the secondary transform is used only in the vertical direction (i.e., along columns).

Finally, for Category 2 intra prediction modes, if the prediction is performed using both the left column and the top row (i.e., intra prediction modes are VER-1, VER-2, . . . VER-8 or HOR-1, HOR-2, . . . HOR-7, or if the intra prediction mode is Planar (a non-directional mode)), then decoder operation 507 is performed and the secondary transform is applied in both the horizontal and vertical directions. Of course, it is to be understood that the encoder implementation is a straightforward inverse of the decoder implementation.

### 1.9 Techniques for Reducing Latency in Secondary Transform

In general, performing a secondary transform after a primary transform such as DCT would require additional cycles for execution, which can pose latency overhead in the encoder/decoder. The following exemplary process in the context of 2-d transforms minimizes this latency. As an example of its application, a worst case scenario from FIG. 5, in which the mode-dependent secondary transform is applied along both the horizontal and vertical directions, is considered.

At the encoder, it is assumed that the N×N horizontal DCT is performed, followed by the N×N vertical DCT. Let C be the N×N DCT, X be the N×N input block, and S be the K×K secondary transform. The mathematical operations that need to be carried out are:

Y=C^{T}*X*C;

and

Z(1:K,1:K)=S^{T}*Y(1:K,1:K)*S

Z(K+1:N,K+1:N)=Y(K+1:N,K+1:N);

Z(1:K,K+1:N)=Y(1:K,K+1:N);

Z(K+1:N,1:K)=Y(K+1:N,1:K);

where Y is an intermediate N×N matrix, and Z is the output N×N transformed matrix (after DCT and secondary transform). Note that the above equations simply indicate that the K×K low frequency coefficients of Y are multiplied by the secondary transform.

For vertical DCT to begin, the operations for all the N rows of horizontal DCT should finish. For example, for the 8×8 DCT it is determined that:

$$[ {C}^{T} ] [ \begin{matrix}{x}_{1}^{T} \\ {x}_{2}^{T} \\ {x}_{3}^{T} \\ {x}_{4}^{T} \\ {x}_{5}^{T} \\ {x}_{6}^{T} \\ {x}_{7}^{T} \\ {x}_{8}^{T}\end{matrix} ] [ \begin{matrix}{c}_{1} & {c}_{2} & {c}_{3} & {c}_{4} & {c}_{5} & {c}_{6} & {c}_{7} & {c}_{8} ]\end{matrix}$$

That is, the rows x₁^{T} to x₈^{T} of X are multiplied sequentially by the basis vectors of DCT (i.e., c₁ to c₈). In the first clock cycle, the processing of x₁^{T} begins (i.e., x₁^{T} is multiplied by c₁ to c₈) to obtain the first row of X*C. This is finished by L=(1−1)+L cycles, where L denotes the latency for DCT.

At the beginning of the 2^{nd} clock cycle, processing of x₂^{T} starts to obtain the 2^{nd} row of X*C. This finishes by 1+L=(2−1)+L cycles. Finally, at the end of (8−1)+L clock cycles, the 8 rows of horizontal DCT are obtained. To generalize, for an N-point transform, it takes N+L−1 cycles to complete.

Once the horizontal DCT finishes, the vertical DCT is determined as:

$$[ \begin{matrix}{c}_{1}^{T} \\ {c}_{2}^{T} \\ {c}_{3}^{T} \\ {c}_{4}^{T} \\ {c}_{5}^{T} \\ {c}_{6}^{T} \\ {c}_{7}^{T} \\ {c}_{8}^{T}\end{matrix} ] [ \begin{matrix}{x}_{1}^{T} {c}_{1} & {x}_{1}^{T} {c}_{2} & {x}_{1}^{T} {c}_{3} & {x}_{1}^{T} {c}_{4} & {x}_{1}^{T} {c}_{5} & {x}_{1}^{T} {c}_{6} & {x}_{1}^{T} {c}_{7} & {x}_{1}^{T} {c}_{8} \\ {x}_{2}^{T} {c}_{1} & {x}_{2}^{T} {c}_{2} & {x}_{2}^{T} {c}_{3} & {x}_{2}^{T} {c}_{4} & {x}_{2}^{T} {c}_{5} & {x}_{2}^{T} {c}_{6} & {x}_{2}^{T} {c}_{7} & {x}_{2}^{T} {c}_{8} \\ & & & & ⋮ & & & \\ & & & & ⋮ & & & \\ & & & & ⋮ & & & \\ & & & & ⋮ & & & \\ & & & & ⋮ & & & \\ {x}_{8}^{T} {c}_{1} & {x}_{8}^{T} {c}_{2} & {x}_{8}^{T} {c}_{3} & {x}_{8}^{T} {c}_{4} & {x}_{8}^{T} {c}_{5} & {x}_{8}^{T} {c}_{6} & {x}_{8}^{T} {c}_{7} & {x}_{8}^{T} {c}_{8}\end{matrix} ]$$

This will take another 8+L−1 cycles (i.e., the vertical DCT can be carried out step by step for the 1^{st} column of the above matrix, followed by 2^{nd} column and so on). Hence, in general, a 2-d N-point DCT will require 2*(N+L−1) cycles for the horizontal and vertical transform.

Similarly, for the 2-d K-point secondary transform, the number of cycles required would be 2*(K+M−1) where M is the latency for a row of secondary transform. Typically, for K≦8, M=1 or 2.

The total worst case overhead if the 2-d secondary transform is applied after the 2-d DCT finishes would be 2*(K+M−1)/[2*(N+L−1)]=(K+M−1)/(N+L−1). For example, for N=8, L=1, K=8, and M=1, overhead is determined to be 100%, which might not be acceptable. For N=32, L=2, K=8, and M=1, overhead is determined to be 8/33=24.24%.

According to an exemplary method of reducing the overhead, a secondary transform can be applied for the rows/columns immediately after the DCT is completed. More specifically, the following order is provided:

Horizontal (Hor) DCT

Vertical (Vert) DCT

Vertical Secondary Transform

Horizontal Secondary Transform

As soon as the 1^{st} column of the Vertical DCT is processed, the processing of the 1^{st} column of the Vertical secondary transform can begin via a pipelined architecture. Such flexibility would not have been available if the horizontal secondary transform was required to be taken after the Vertical DCT. In that case, it would be required to wait until all the N rows of the vertical DCT have been processed.

Assuming N>>K (e.g., N=32, and K=8), a timing diagram for the operations of Vertical DCT (which begins after N+L−1 cycles), Vertical ST, and Horizontal ST is illustrated in Table 1.

TABLE 1

| | | | | | | | | | | | | | | | (N + L − | | |
|---|---|---|---|---|---|---|---|---|---|---|---|---|---|---|---|---|---|
| | | | | | | | | | | | | | (N + L − | | 1) + L + | | |
| | | | | | | | (N + | | | | (N + L − | | 1) + L + | | M + (K − | | (N + L − |
| | | | | | N + | | L − | | (N + L − | | 1) + L + | | M + (K − | | 1) + M + | | 1) + (N + |
| Time | 0 | . . . | L | . . . | L − 1 | . . . | 1) + L | . . . | 1) + L + M | . . . | M + (K − 1) | . . . | 1) + M | . . . | K − 1 | . . . | L − 1) |

| | | | | | | | | | |
|---|---|---|---|---|---|---|---|---|---|
| Hor DCT | 1 | . . . | N | | | | | | |
| Vert DCT | | | | 1 | | | | | N |
| Vert ST | | | | | 1 | K | | | |
| Hor ST | | | | | | | 1 | K | |

In Table 1, the row corresponding to Hor DCT shows the time when a particular row of DCT finishes. For example, the 1st row of Hor DCT finishes after L clock cycles, and row N finishes after (N+L−1) cycles. Similarly, for Vertical DCT, the 1st column finishes at (N+L−1)+L cycles. Exactly at this point, the processing of the secondary transform for the first column of the secondary transform can begin. This finishes within an additional M cycles at time (N+L−1)+L+M.

The vertical ST is completed at (N+L−1)+L+M+K−1 as shown above and now the horizontal ST can begin. This finishes in another M+K−1 cycles.

In this way, the total time for the Vertical and Horizontal ST to finish is:

T_{ST}=(N+L−1)+L+2*(M+K−1)cycles.

For DCT only, the time is:

T_{DCT}=2*(N+L−1)cycles

Thus, the Additional Cycles equal:

$$\begin{matrix}{T}_{ST} - {T}_{DCT} = L + 2 * ( M + K - 1 ) - ( N + L - 1 ) \\ = 2 K + 2 M - 1 - N\end{matrix}$$

It is also noted that the secondary transform can sometimes finish before the DCT itself (e.g., when N=32, K=8). In that case, T_{ST}<T_{DCT}, and hence there is no overhead. So, the above formula for Additional Cycles can be determined as:

Additional Cycles=max(0,2K+2M−1−N)

Therefore, the overhead is determined as:

$$= max ( 0 , 2 K + 2 M - 1 - N ) / {T}_{DCT} \\ = max ( 0 , 2 K + 2 M - 1 - N ) / [ 2 * ( N + L - 1 ) ]$$

As an example, for the 32×32 DCT, when N=32, the overhead latency for secondary transform at size K=8 is (assuming M=L=1) max (0,−15)/[2*32]=0. Of course, it is to be understood that the values of M=L=1 are merely for example.

For N=16, if K<=7, and M=1, then max (0,2K+2−1−16)<=max (0,−1). Therefore, for secondary transforms of size up to 7×7, there is no overhead. For the 8×8 secondary transform, the overhead is 1/32=3.125%

For N=8, assuming L=M=1, the total number of cycles for DCT is 2*(8+1−1)=16. For this case, the secondary transform is illustrated in Table 2.

TABLE 2

| K (Secondary | Overhead, =max 0, 2K + 2M − | Overhead in |
|---|---|---|
| Transform Size) | 1 − N)/[2*(N + L − 1)] | Percentage |
| 2 | 0 | 0 |
| 3 | 0 | 0 |
| 4 | 1 | 6.25 |
| 5 | 3 | 18.75 |
| 6 | 5 | 31.25 |
| 7 | 7 | 43.75 |
| 8 | 9 | 56.25 |

From the above calculations, it appears that for N=8, a secondary transform of size 8×8 has a large overhead of 56.25%. However, in this case, the latency can be reduced by using a different logic for implementing 8×8 2-d DCT and 8×8 2-d Secondary Transform. Specifically, the following logic can be used:

Hor DCT

Hor Secondary Transform

Vertical DCT

Vertical Secondary Transform

In the above implementation, the 1^{st} row of the secondary transform can be started as soon as the 1^{st} row of DCT finishes. The last of the 8^{th} row of secondary transform takes an additional M cycles after the Horizontal DCT Immediately after the horizontal secondary transform finishes, the Vertical DCT can begin, and the Vertical secondary transform can finish M cycles after the Vertical DCT.

Therefore, the overall additional cycles=2*M, and hence overhead=2*M/2(8+L−1). Assuming M=L=1, overhead=2/16=12.5%, which is much less than 56.25% in the implementation above.

A similar logic can be used for 7×7 secondary transform when DCT is of size 8×8, but such a scheme will require an additional buffer of size 7×7, since the secondary transform only needs to be applied on the top 7×7 block of 8×8 DCT.

If a parallel implementation for DCT or secondary transform is used, then the latency for the secondary transform can be further reduced.

If the order of application of DCT is vertical followed by horizontal, then the secondary transform needs to be applied as horizontal secondary transform, followed by vertical secondary transform to reduce the latency as explained above.

For Short Distance Intra Prediction (SDIP), there can be rectangular blocks of size 1×16, 2×8, 2×32, 4×16 and 8×32. In this case, the DCT may first be applied to the smaller of the dimension. For example, for 8×32 (or 2×32 case), apply 8-point vertical DCT (or 2-point DCT) followed by 32-point horizontal DCT. In such a case, the secondary transform (of size 2×2 to 8×8) can be easily completed between the 9^{th} to 24^{th} columns of 32-point DCT. Thus, there is no overhead in this case.

For the 1×16 and 4×16 case, the secondary transform would be required only after 16-point DCT in the vertical direction, and can be simply performed between the 2^{nd} to 9^{th} columns via pipelining. Thus, there is no overhead in this case as well. Finally, for the 2×8 case, the secondary transform can begin only after the 1^{st} column of 8-point DCT. The additional latency would be M cycles (i.e., for the last column), implying overhead would be M/(2+8)=M/10=10% (assuming L=M=1).

The above analysis considered the worst-case scenario in which a secondary transform needs to be applied in both the directions. However, in many cases illustrated in FIG. 5, the secondary transform would be applied only in one direction or none. In such cases, the additional latency would decrease.

At the decoder, the latencies and overhead for a particular size of N×N DCT, and K×K secondary transform via an inverse realization as compared to the encoder, would be exactly the same as for the encoder.

The following implementation at a decoder is considered as an example:

Horizontal Inverse Secondary Transform

Vertical Inverse Secondary Transform

Vertical Inverse DCT

Horizontal Inverse DCT

Notably, this is the inverse of the first example provided above for the forward transform at the encoder.

When the K rows of the horizontal inverse secondary transform are processed in K+M−1 cycles, K vertical columns (out of the N−K columns on which no horizontal or vertical inverse secondary transform needs to be taken, when K<N−K) of DCT can be processed in K+L−1 cycles.

If K≧N−K, then it is possible to process only N−K columns while the horizontal inverse secondary transform finishes. Thus, min (K, N−K) columns of inverse Vertical DCT can be processed in K+L−1 cycles.

Next, when the inverse Vertical secondary transform is being taken from the beginning of K+M−1 cycles, we have N−min (K, N−K) columns left. This may be considered as two cases. First, if K≧N−K, then there are K columns left (i.e., on which vertical inverse secondary transform would be taken). On the other hand, if N−K>K, then N−K columns are left. The K columns for DCT can be processed as well via a pipelined architecture, and this will require only M+K+L−1 cycles, where M is because of the latency of the secondary transform's first column for the first case above. For the second case, K columns can be processed in K+L−1 cycles only, and this can be stated after K cycles only (instead of K+M−1).

Hence, at the end of (K+M−1)+M+K+L−1 cycles, (if K≧N−K) or K+K+L−1 cycles (if K<N−K), the horizontal and vertical inverse secondary transforms are finished, and min (K,N−K)+K columns of inverse vertical DCT are also processed.

The remaining number of columns for inverse DCT is N−K−min (K,N−K) which is determined as:

$$= N - K - ( N - K ) = 0 if K >= N - K$$

$$or \\ = N - K - K = N - 2 K if K < N - K , i . e . , 2 K < N$$

Hence, the remaining columns=0 if 0≧N−2K, or N−2K if N−2K≧0.

These remaining columns can be processed in an additional 0 or N−2K cycles, i.e., max (0, N−2K) cycles. Finally the horizontal inverse DCT takes N+L−1 cycles. Hence, total cycles=K+M−1+M+K+L−1+max (0, N−2K)+N+L−1=T_{Dec} if K>=N−K. Or total cycles=K+K+L−1+max (0, N−2K)+N+L−1=T_{Dec} if K<N−K.

Therefore, the number of additional cycles at the decoder is given by T_{Dec}−T_{DCT}. Thus, if K>=N−K, the number of additional cycles T_{Dec}−T_{DCT} is determined as:

$$= K + M - 1 + M + K + L - 1 + max ( 0 , N - 2 K ) + N + L - 1 - 2 * ( N + L - 1 ) = 2 * ( K + M - 1 ) + L - ( N + L - 1 ) + max ( 0 , N - 2 K ) = 2 * K + 2 * M - N - 1 + max ( 0 , N - 2 K ) = 2 K + 2 M - N - 1 + 0 ( since 0 > N - 2 K )$$

On the other hand, if K<N−K, then the number of additional cycles T_{Dec}−T_{DCT} is determined as:

$$= K + K + L - 1 + max ( 0 , N - 2 K ) + N + L - 1 - 2 * ( N + L - 1 ) = 2 K - 1 + L + N - 2 K - ( N + L - 1 ) = 0$$

Combining the two terms above, it is determined that the additional cycles=max (0, 2K+2M−N−1) which is the same as derived in the first example above, and hence:

$$\begin{matrix}overhead = max ( 0 , 2 K + 2 M - 1 - N ) / {T}_{DCT} \\ = max ( 0 , 2 K + 2 M - 1 - N ) / [ 2 * ( N + L - 1 ) ]\end{matrix}$$

When considering the decoder, the horizontal inverse DCT is taken first and then the vertical inverse DCT, the order for secondary transforms should be:
Vertical inverse secondary transform,
Horizontal inverse secondary transform
Horizontal inverse DCT
Vertical inverse DCT

Finally, all the derivations regarding the encoder hold true for the decoder due to symmetry including statements regarding parallelization, application to SDIP block, etc. Also, for the 8×8 secondary transform and 8×8 DCT, we can reduce the latency by the following logic (which is the inverse of the second example above):
Vertical inverse secondary transform
Vertical inverse DCT
Horizontal inverse secondary transform
Horizontal inverse DCT
   2. Deriving Secondary Transforms from Primary Alternate Transform when the Correlation Coefficient in the Covariance Matrix of Intra Residues in Gauss-Markov Model is Varied

In JCTVC-F138, the following 8×8 KLT matrix K₈ (with basis vectors in rows) is presented for intra residues at block size 8×8. That is, K₈ is determined as:

$$[ \begin{matrix}26 & 46 & 59 & 68 & 74 & 76 & 75 & 71 ; \\ 49 & 81 & 84 & 56 & 8 & - 41 & - 75 & - 79 ; \\ 69 & 77 & 17 & - 61 & - 91 & - 48 & 32 & 81 ; \\ 85 & 43 & - 62 & - 72 & 28 & 87 & 16 & - 78 ; \\ 86 & - 21 & - 83 & 36 & 73 & - 55 & - 64 & 66 ; \\ 78 & - 70 & - 13 & 83 & - 62 & - 25 & 86 & - 53 ; \\ 58 & - 87 & 71 & - 19 & - 43 & 82 & - 80 & 36 ; \\ 31 & - 58 & 78 & - 87 & 84 & - 71 & 48 & - 19\end{matrix} ]$$

Also, let the transposed matrix for the KLT be G₈=K^{T}, which is determined as:

$$[ \begin{matrix}26 & 49 & 69 & 85 & 86 & 78 & 58 & 31 \\ 46 & 81 & 77 & 43 & - 21 & - 70 & - 87 & - 58 \\ 59 & 84 & 17 & - 62 & - 83 & - 13 & 71 & 78 \\ 68 & 56 & - 61 & - 72 & 36 & 83 & - 19 & - 87 \\ 74 & 8 & - 91 & 28 & 73 & - 62 & - 43 & 84 \\ 76 & - 41 & - 48 & 87 & - 55 & - 25 & 82 & - 71 \\ 75 & - 75 & 32 & 16 & - 64 & 86 & - 80 & 48 \\ 71 & - 79 & 81 & - 78 & 66 & - 53 & 36 & - 19\end{matrix} ]$$

Then, similar to the analysis above, this can first be made into a secondary matrix H₈=C₈^{T}*G₈. The basis vectors of the above matrix G have norm 128*sqrt(2). To have a secondary transform with norm 128 (so as to allow a 7-bit down-shift after application of the secondary transform), H₈=round(C₈^{T}*G₈/sqrt(2))) is determined as:

$$[ \begin{matrix}124 & 21 & 19 & 12 & 10 & 6 & 5 & 2 \\ - 28 & 118 & 24 & 28 & 12 & 12 & 5 & 4 \\ - 17 & - 36 & 118 & 21 & 21 & 9 & 8 & 3 \\ - 4 & - 26 & - 35 & 117 & 20 & 17 & 6 & 4 \\ - 4 & - 4 & - 20 & - 30 & 121 & 17 & 11 & 3 \\ - 2 & - 6 & - 5 & - 17 & - 24 & 123 & 13 & 7 \\ - 2 & - 1 & - 5 & - 4 & - 11 & - 17 & 126 & 8 \\ 0 & - 2 & - 1 & - 3 & - 2 & - 7 & - 9 & 127\end{matrix} ]$$

It is noted that the actual floating point 8×8 DCT was used above. If an alternative DCT is used (i.e., with norm 128 sqrt (2) for basis vectors), then C_{8,E-243} is determined as:

$$[ \begin{matrix}64 & 89 & 83 & 75 & 64 & 50 & 36 & 18 \\ 64 & 75 & 36 & - 18 & - 64 & - 89 & - 83 & - 50 \\ 64 & 50 & - 36 & - 89 & - 64 & 18 & 83 & 75 \\ 64 & 18 & - 83 & - 50 & 64 & 75 & - 36 & - 89 \\ 64 & - 18 & - 83 & 50 & 64 & - 75 & - 36 & 89 \\ 64 & - 50 & - 36 & 89 & - 64 & - 18 & 83 & - 75 \\ 64 & - 75 & 36 & 18 & - 64 & 89 & - 83 & 50 \\ 64 & - 89 & 83 & - 75 & 64 & - 50 & 36 & - 18\end{matrix} ]$$

and H_{8,E-243}=round(C_{8,E-243}^{T}*G₈/sqrt(2)) is determined as:

$$[ \begin{matrix}124 & 21 & 19 & 12 & 10 & 6 & 5 & 2 \\ - 28 & 118 & 24 & 28 & 11 & 12 & 5 & 3 \\ - 17 & - 36 & 118 & 21 & 21 & 9 & 6 & 2 \\ - 4 & - 26 & - 35 & 117 & 20 & 17 & 6 & 4 \\ - 4 & - 4 & - 20 & - 30 & 121 & 17 & 12 & 3 \\ - 2 & - 6 & - 5 & - 17 & - 24 & 123 & 13 & 7 \\ - 2 & - 1 & - 3 & - 4 & - 11 & - 17 & 126 & 8 \\ 0 & - 2 & - 1 & - 3 & - 2 & - 7 & - 9 & 127\end{matrix} ]$$

which can be used in conjunction with the DCT above.

For the G₈ matrix derived above, the value of the correlation coefficient was taken to be rho=0.65. For discussion, it is denoted as K_{8,0.65} where the subscripts indicate block-size and the value of rho. A different KLT K_{8,rho} can be derived using a different value of rho (e.g., 0.6, 0.7, etc., in general rho is a real number between −1 and 1). The same analysis can then be performed for any Kᵣₕₒ as was performed for K_{0.65}.

Finally, the same analysis can be performed at any block-size N×N (such as 4×4) where N-point KLT K_{N,rho} (or the 4-point KLT K_{4,rho}) is derived for a given rho.

Notably, the above discussion concerned application of a secondary transform for intra prediction residues. The following discussion relates to application of a secondary transform to inter residues.

### 2.1 Technique for Applying Secondary Transform for Inter Residues

FIG. 7 illustrates a split Prediction Unit (PU) and an error distribution within the top-left Transform Unit (TU) according to the related art.

Referring to FIG. 7, a possible distribution of energy of residue pixels in an Inter-Prediction Unit (PU) 701 and Transform Unit (TU) 703 is illustrated. When considering the horizontal transform, it may be assumed that the energy of the residues is greater at the boundary as compared to the middle of the PU as shown in FIG. 1. Thus, for TU₁, a transform with an increasing first basis function such as DST-Type 7 would be better than DCT. It may further be considered to use a “flipped” DST for TU₀ to mimic the behavior of energy of residue pixels in TU₀.

### 2.1.1 Applying Secondary Transform Via Multiple “Flips”

As opposed to using a “flipped” DST, the data can be flipped as well. Based on this reasoning, a secondary transform can be applied as follows at larger blocks for TU₀, such as 32×32 instead of a 32×32 DCT. The following is an exemplary process at an encoder by which to flip the data.

First, the input data is flipped. That is, for N-point input vector x, with entries xᵢ, i=1 . . . N, define y with elements yᵢ=x_{N+1-i}. Next, take the DCT of y and denote the output as z. Finally, apply a secondary transform on the first K elements of z. Let the output be w, where the remaining “N−K” high-frequency elements are copied from z, on which the secondary transform was not applied.

Similarly at the decoder, input for the transform module may be considered v, which is a quantized version of w. In that case, the following exemplary steps can be performed for taking the inverse transform. First, apply an inverse secondary transform on the first K elements of v. Let the output be b (where the “N−K” high frequency coefficients are identical to that of v). Next, take the inverse DCT of b and denote the output as d. Finally, flip the data in d (i.e., define f with elements fᵢ=d_{N+1-i}). Then f is the reconstructed values for the pixels x.

For TU₁, the flipping operations need not be required, and a simple DCT followed by secondary transform only needs to be taken at the encoder. At the decoder, it is merely necessary to take an inverse secondary transform followed by an inverse DCT.

It is noted that the flipping operations at the encoder and decoder for TU₀ can be expensive in hardware. As an alternative, the secondary transforms may be adapted for these “flip” operations. That is, the adaptation of the secondary transforms would avoid the necessity of flipping the data. As an example, it is assumed that the N-point input vector x with entries x₁ to x_{N} in TU₀ needs to be transformed appropriately. Let the 2-d N×N DCT matrix be denoted as C with elements C (i,j), where 1≦(i,j)≦N. As an example, a normalized (e.g., by 128*sqrt(2)) 8×8 DCT is determined as:

$$[ \begin{matrix}64 & 89 & 84 & 75 & 64 & 50 & 35 & 18 \\ 64 & 75 & 35 & - 18 & - 64 & - 89 & - 84 & - 50 \\ 64 & 50 & - 35 & - 89 & - 64 & 18 & 84 & 75 \\ 64 & 18 & - 84 & - 50 & 64 & 75 & - 35 & - 89 \\ 64 & - 18 & - 84 & 50 & 64 & - 75 & - 35 & 89 \\ 64 & - 50 & - 35 & 89 & - 64 & - 18 & 84 & - 75 \\ 64 & - 75 & 35 & 18 & - 64 & 89 & - 84 & 50 \\ 64 & - 89 & 84 & - 75 & 64 & - 50 & 35 & - 18\end{matrix} ]$$

with basis vectors along columns. Note that in DCT, C(i,j)=(−1)(j−1)*C(N+1−i, j), i.e., the odd (first, third . . . ) basis vectors of DCT are symmetric about the half-way mark. And the even (second, fourth, . . . ) basis vectors are symmetric but have opposite signs. This is a very important property of DCT which can be utilized to appropriately “modulate” the secondary transform.
2.1.2 Applying Secondary Transform without “Flips”

A flipped version of x is y with elements yᵢ=x_{N+1-i}. In that case, DCT of y is given by:

$$\begin{matrix}{z}_{j} = {\sum }_{i = 1}^{N} {y}_{i} * C ( i , j ) \\ = {\sum }_{i = 1}^{N} {y}_{N + 1 - i} * C ( N + 1 - i , j ) \\ = {\sum }_{i = 1}^{N} {x}_{i} * C ( N + 1 - i , j ) \\ = {( - 1 )}^{j - 1} * {\sum }_{i = 1}^{N} {x}_{i} * C ( i , j )\end{matrix}$$

Because the objective is to avoid actual flipping, it is possible to take the DCT of x, and then, while taking the secondary transform, incorporate the factor (−1)^{(j-1)}.

Now, let S(j,k) denote the elements of K×K secondary matrix S. The secondary transform of z, whose output is denoted by w, is as follows:

$$\begin{matrix}{w}_{k} = {\sum }_{j = 1}^{K} {z}_{j} * S ( j , k ) \\ = {\sum }_{j = 1}^{K} {( - 1 )}^{j - 1} {\sum }_{i = 1}^{N} {x}_{i} \cdot C ( i , j ) \cdot S ( j , k ) \\ = {\sum }_{j = 1}^{K} \{ {( - 1 )}^{j - 1} S ( j , k ) \} \{ {\sum }_{i = 1}^{N} {x}_{i} \cdot C ( i , j ) \}\end{matrix}$$

for k=1:K.

For K<k≦N, wₖ is determined as:

$${w}_{k} = {z}_{k} = {( - 1 )}^{k - 1} * {\sum }_{i = 1}^{N} {x}_{i} * C ( i , k )$$

In summary, to avoid flipping in the first step at the encoder, while taking the secondary transform, multiply by (−1)^{(j-1)}*S(j,k) instead of S(j,k) for the first K elements. For the remaining elements (K<k≦N), flip the sign of alternate DCT coefficients according to the equation above for wₖ.

### Decoder Operations:

According to the three steps applicable to a decoder as described above in Sec 2.1.1, it is necessary to take an inverse secondary transform, inverse DCT, and then flip the data. Mathematically, for an input v, the inverse secondary transform denoted by P (j,k) is taken as follows:

$${b}_{k} = {\sum }_{j = 1}^{K} {v}_{j} * P ( j , k )$$

for 1≦k≦K.

For K<k≦N, bₖ=(−1)^{(k-1)}*vₖ, which is the direct inverse of the events at the encoder.

Next, the input to the inverse DCT module will be b. The inverse DCT of b is d, and would be given by:

$${d}_{j} = {\sum }_{i = 1}^{N} {b}_{i} * M ( i , j )$$

where M=C⁻¹=C^{T} is the inverse DCT matrix. Specifically, at size 8×8, M is determined as:

$$[ \begin{matrix}64 & 64 & 64 & 64 & 64 & 64 & 64 & 64 \\ 89 & 75 & 50 & 18 & - 18 & - 50 & - 75 & - 89 \\ 84 & 35 & - 35 & - 84 & - 84 & - 35 & 35 & 84 \\ 75 & - 18 & - 89 & - 50 & 50 & 89 & 18 & - 75 \\ 64 & - 64 & - 64 & 64 & 64 & - 64 & - 64 & 64 \\ 50 & - 89 & 18 & 75 & - 75 & - 18 & 89 & - 50 \\ 35 & - 84 & 84 & - 35 & - 35 & 84 & - 84 & 35 \\ 18 & - 50 & 75 & - 89 & 89 & - 75 & 50 & - 18\end{matrix} ]$$

Note that, similar to DCT C, the property of M is determined as:

M(i,j)=(−1)⁽ⁱ⁻¹⁾*M(i,N+1−j)

Finally, according to the third step at the decoder, the elements of f and d are flipped, resulting in:

$$\begin{matrix}{f}_{j} = {d}_{N + 1 - j} \\ = {\sum }_{i = 1}^{N} {b}_{i} * M ( i , N + 1 - j ) \\ = {\sum }_{i = 1}^{N} {( - 1 )}^{i - 1} * {b}_{i} * M ( i , j ) \\ = {\sum }_{i = 1}^{N} {\sum }_{l = 1}^{K} {( - 1 )}^{i - 1} * {v}_{l} * P ( l , i ) * M ( i , j ) \\ = {\sum }_{i = 1}^{N} M ( i , j ) * {\sum }_{l = 1}^{K} {( - 1 )}^{i - 1} * P ( l , i ) * {v}_{l}\end{matrix}$$

This means that while taking the inverse secondary transform, instead of multiplying by elements P (1,i), we should multiply by (−1)ⁱ⁻¹*P (1,i) to avoid flipping at the end.

### 2.2 Extensions for Vertical Secondary Transform

For the case of TU₀ in FIG. 7, when a vertical transform is taken, it would be necessary to flip the data since energy would be increasing upwards. Alternatively, the coefficients of the secondary transform may be appropriately modulating as in section 2.1 above. The extension can be carried out in a straightforward fashion.

2.3 Deriving a Primary Transform from a Secondary Transform

In case it is necessary to use a primary transform of size 8 derived from a secondary transform, an exemplary process is provided here.

First, let the secondary transform of size 8 be P, and DCT at size 8 be C. Then, a primary alternate transform can be derived as Q=C*P. Thus, if P is determined as:

$$[ \begin{matrix}123 & 32 & - 14 & 7 & - 4 & 3 & - 2 & 2 \\ - 35 & 120 & - 24 & 11 & - 7 & 4 & - 3 & 2 \\ - 8 & - 29 & - 123 & 17 & - 8 & 5 & - 3 & 3 \\ - 3 & - 10 & 21 & 125 & - 13 & 6 & - 4 & 3 \\ - 2 & - 5 & 8 & - 16 & - 126 & 11 & - 5 & 3 \\ - 1 & - 3 & 4 & - 7 & 13 & 127 & - 9 & 5 \\ - 1 & - 2 & 3 & - 4 & 5 & - 10 & - 127 & 8 \\ - 1 & - 1 & 2 & - 2 & 3 & - 5 & 9 & 128\end{matrix} ]$$

then Q=round(C*P/128), which is determined as:

$$[ \begin{matrix}28 & 70 & - 85 & 83 & - 76 & 63 & - 47 & 30 \\ 42 & 86 & - 67 & 13 & 43 & - 81 & 86 & - 58 \\ 52 & 78 & 2 & - 81 & 76 & 0 & - 75 & 78 \\ 62 & 53 & 66 & - 65 & - 51 & 83 & 23 & - 89 \\ 70 & 13 & 88 & 35 & - 71 & - 70 & 44 & 85 \\ 76 & - 28 & 47 & 89 & 57 & - 24 & - 87 & - 70 \\ 80 & - 62 & - 26 & 24 & 68 & 89 & 82 & 48 \\ 82 & - 82 & - 80 & - 72 & - 62 & - 48 & - 34 & - 16\end{matrix} ]$$

Note that Q is “rounded” since, in actual hardware, it is necessary to carry operations using integers, rather than floating point numbers.

A flipped version of Q would be Q₂, which is determined as:

$$[ \begin{matrix}82 & - 82 & - 80 & - 72 & - 62 & - 48 & - 34 & - 16 \\ 80 & - 62 & - 26 & 24 & 68 & 89 & 82 & 48 \\ 76 & - 28 & 47 & 89 & 57 & - 24 & - 87 & - 70 \\ 70 & 13 & 88 & 35 & - 71 & - 70 & 44 & 85 \\ 62 & 53 & 66 & - 65 & - 51 & 83 & 23 & - 89 \\ 52 & 78 & 2 & - 81 & 76 & 0 & - 75 & 78 \\ 42 & 86 & - 67 & 13 & 43 & - 81 & 86 & - 58 \\ 28 & 70 & - 85 & 83 & - 76 & 63 & - 47 & 30\end{matrix} ]$$

and this can be used instead of DST Type-7 as an alternate transform.

### 3. 4×4 DST for Chroma

The 4×4 DST in HM is currently only for Luma components. For Chroma, there are certain prediction modes available.

Vertical, Horizontal and DC Modes (respectively denoted as modes 0, 1 and 2) are provided in HM 3.0. Here, for the vertical (respectively horizontal) mode, the transform along the direction of vertical (respectively horizontal) prediction can be DST, since it has been shown that DST is the better transform along the direction of prediction. In the other direction, DCT can be the transform. For the DC mode, since there is no directional prediction, DCT can be retained as the transform in both directions.

For the Planar mode, DST may be used as the horizontal and vertical transform for a 4×4 Chroma block coding similar to the 4×4 Luma block coding using DST in HM 3.0.

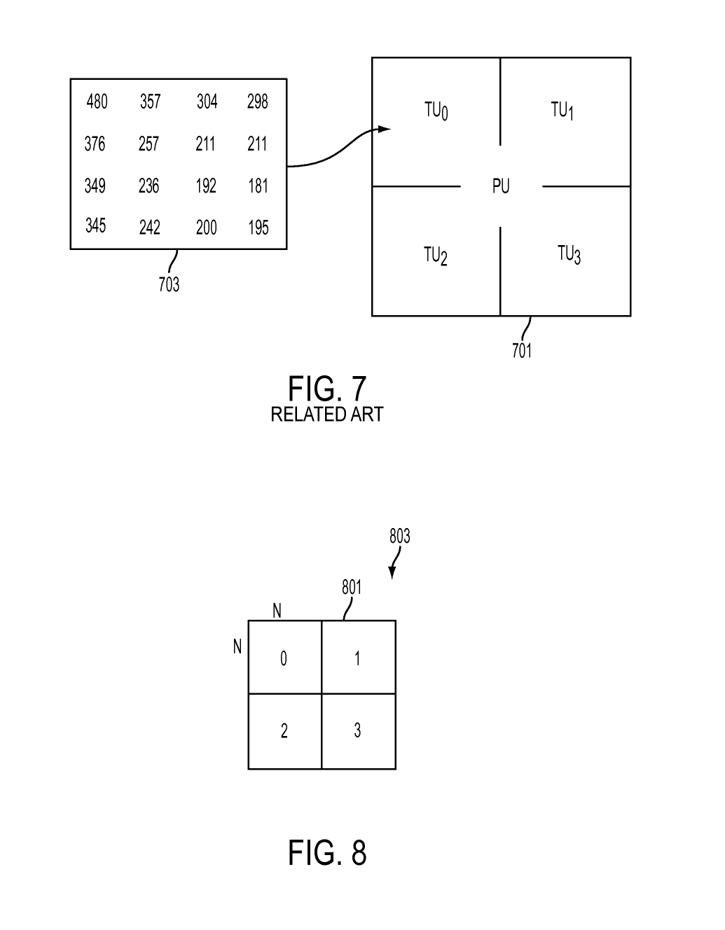

FIG. 8 illustrates the partitioning of a prediction unit of size 2N×2N into transform units of size N×N according to an exemplary embodiment of the present invention.

Referring to FIG. 8, for Chroma Mode derived from Luma Mode (DM mode), the Chroma mode at block size N×N 801 is derived from the associated 2N×2N Luma mode prediction unit 803. In general, the same mapping can be used for all the modes to transform. However, experimental results with HM 3.0 showed that the gains of using this mapping table for derived mode (DM) mode are marginal, and sometimes cause loss in Chroma BD Rates. Thus, DCT is retained as the transform for this mode.

For the Horizontal, Vertical and Planar modes in DM mode, DST and DCT combination may be used, similarly to when these modes are in Regular mode. This is based on two reasons. First, if a different transform combination for Horizontal mode (in Regular explicitly signaled mode, or as part of DM mode) is used, then the encoder would have to calculate this twice (e.g., using DST/DCT for the horizontal-regular mode), and only DCT for the horizontal-derived mode. This can make the encoder slow. Second, there could be entropy coding performed at the encoder side, where both the horizontal-regular mode and horizontal-derived mode can be mapped to the same index. The decoder would therefore be unable to distinguish between horizontal-regular and horizontal-derived mode. Therefore, it can not decide if a different transform scheme needs to be used depending on the horizontal-regular and horizontal-derived mode. A possible solution can be that the encoder sends a flag for this. But, this will increase the data (i.e., bits) and reduce the compression efficiency.

The same logic can be applied for Vertical and Planar modes, and therefore for a horizontal (or vertical, or planar)-derived mode, it is possible to use the transforms used for the Vertical, Horizontal, Planar, and DC Modes as described above.

The last prediction mode is the LM Mode in Chroma. Here, Chroma prediction is performed from reconstructed Luma pixels. Hence, this is not a directional mode and DCT can be retained as both the horizontal and vertical transform.

### 4. Mode-Dependent Secondary Transforms for Chroma

Similar to the analysis presented above in Section 3 for DST on 4×4 chroma blocks, it is possible to use Mode-Dependent Secondary Transforms for the horizontal, vertical and planar modes (regular or in DM mode) only of 8×8 or larger square blocks such as 16×16, 32×32 etc., as well as rectangular blocks such as 8×16, 8×32, etc. For rectangular blocks such as 4×16, a 4-point DCT or DST can be used on the dimension 4 and a secondary transform of size 8 can be applied following the DCT used on dimension 16, depending on the intra prediction mode. For the LM mode, no secondary transform would be required and DCT can be retained as both the horizontal and vertical transform.

For the horizontal mode when prediction is performed in the horizontal direction, the secondary transform needs to be applied only in the horizontal direction after the DCT, and no secondary transform should be applied along the vertical direction after the DCT. In a similar fashion, for the vertical mode, when prediction is performed in the vertical direction, the secondary transform needs to be applied only in the vertical direction after the DCT, and no secondary transform should be applied along the horizontal direction after the DCT. For the Planer mode, a secondary transform can be applied as the horizontal and vertical transform after DCT. The decoder operations for applying mode-dependent secondary transform for Chroma are similar to those for Luma, and correspond to the second, third and fourth rows (i.e., operations 503, 505, and 507) of FIG. 5.

### 5. Apparatus for Implementing Secondary Transform

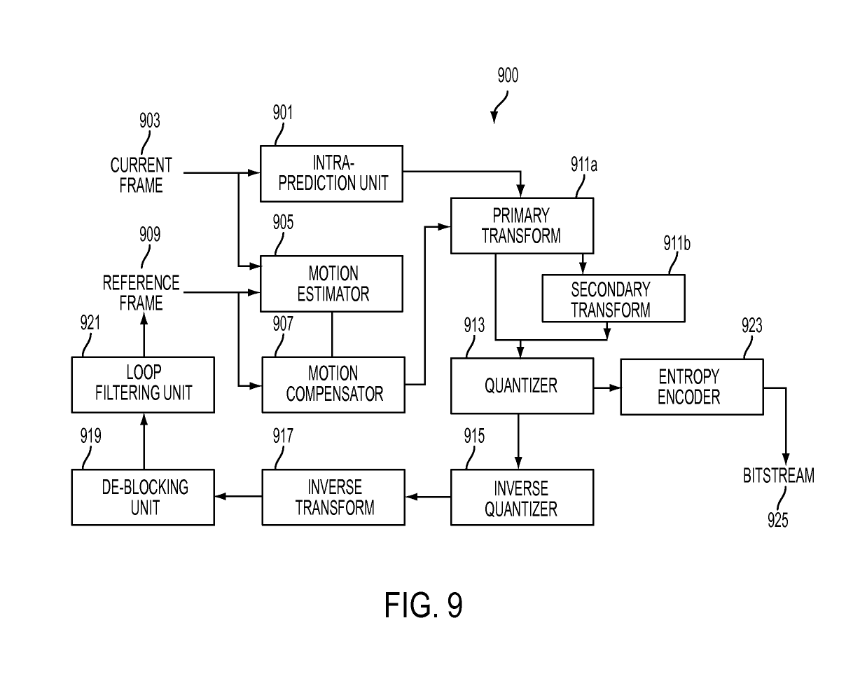

FIG. 9 illustrates a block diagram of a video encoder according to an exemplary embodiment of the present invention.

Referring to FIG. 9, encoder 900 includes an intra prediction unit 901 that performs intra prediction on prediction units of the intra mode in a current frame 903, and a motion estimator 905 and a motion compensator 907 that perform inter prediction and motion compensation on prediction units of the inter prediction mode using the current frame 903 and a reference frame 909.

Residual values are generated based on the prediction units output from the intra-prediction unit 901, the motion estimator 905, and the motion compensator 907. The generated residual values are output as quantized transform coefficients by passing through a primary transform unit 911a and a quantizer 913. According to an exemplary embodiment of the present invention, the residual values may also pass through secondary transform unit 911b after primary transform unit 911a depending on the mode of prediction.

The quantized transform coefficients are restored to residual values by passing through an inverse quantizer 915 and an inverse transform unit 917, and the restored residual values are post-processed by passing through a de-blocking unit 919 and a loop filtering unit 921 and output as the reference frame 909. The quantized transform coefficients may be output as a bitstream 925 by passing through an entropy encoder 923.

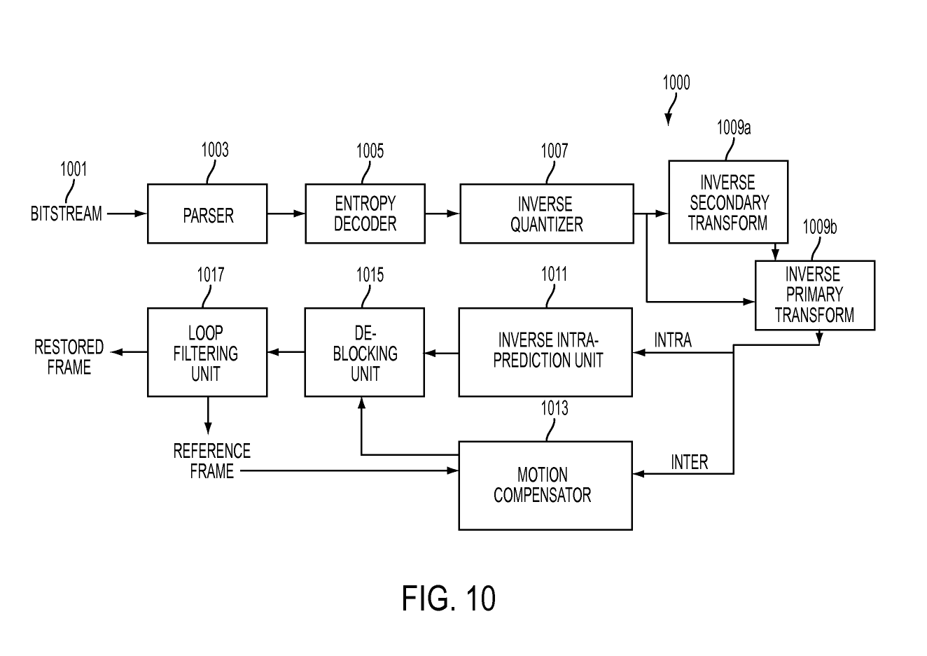

FIG. 10 is a block diagram of a video decoder according to an exemplary embodiment of the present invention.

Referring to FIG. 10, a bitstream 1001 passes through a parser 1003 so that encoded image data to be decoded and encoding information necessary for decoding are parsed. The encoded image data is output as inverse-quantized data by passing through an entropy decoder 1005 and an inverse quantizer 1007 and restored to residual values by passing through an inverse primary transform unit 1009b. According to an exemplary embodiment of the present invention, the data may also be first passed through an inverse secondary transform unit 1009a depending on the mode of prediction before being passed through the inverse primary transform unit 1009b. The residual values are restored according to rectangular block coding units by being added to an intra prediction result of an intra prediction unit 1011 or a motion compensation result of a motion compensator 1013. The restored coding units are used for prediction of next coding units or a next frame by passing through a de-blocking unit 1015 and a loop filtering unit 1017.

To perform decoding, components of the image decoder 1000, i.e., the parser 1003, the entropy decoder 1005, the inverse quantizer 1007, the inverse primary transform unit 1009b, the inverse secondary transform unit 1009a, the intra prediction unit 1011, the motion compensator 1013, the de-blocking unit 1015 and the loop filtering unit 1017, perform the image decoding process.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A method for encoding video data, the method comprising:
determining a primary transform C_{N} for application to residual data;
determining a secondary transform Tr_{K} for application to the residual data;
applying the primary transform C_{N} to the residual data; and
selectively applying the secondary transform Tr_{K} to the residual data,
wherein N denotes the length size of the input vector on which the primary transform C_{N} is applied, and K denotes the length of the first few coefficients of the primary transform output on which the secondary transform Tr_{K} is applied.

2. The method of claim 1, wherein the determining of the secondary transform Tr_{K} comprises:
determining a first correlation matrix R_{N} for length N input data;
determining a second correlation matrix U_{N} for data obtained as a result of application of the primary transform C_{N};
determining a matrix V_{K,N} as the top K rows and K columns for the second correlation matrix U_{N};
determining the Karhunen-Loeve Transform (KLT) of V_{K,N} as W_{K,N}; and
determining an integer based approximation of W_{K,N} as Y_{K,N} and using it as Tr_{K}

3. The method of claim 2, further comprising:
multiplying W_{K,N} by 2^{m}; and
rounding the multiplication result to a nearest integer,
wherein m is an integer >0 and denotes a required precision.

4. The method of claim 2, wherein the obtaining of the subset matrix comprises application of the following equation:
$${V}_{K , Avg} = {\sum }_{i} {p}_{i} {V}_{K , i , Normalized}$$
wherein pᵢ denotes a probability of input being i-point, i denotes a running index for the i-point input distribution with probability pᵢ, V_{K,i,Normalized}=(1/i) V_{K,i}=(1/i) Uᵢ (1:K,1:K), Uᵢ=Cᵢ^{T}*Rᵢ*Cᵢ; Rᵢ is the correlation for i-point input, and Cᵢ is the i×i primary transform.

5. The method of claim 2, further comprising smoothing the first correlation matrix R_{N}.

6. The method of claim 5, wherein the smoothing of the first correlation matrix R_{N} comprises application of the following equation:
p=min(i,j)
R_{N}(i,j)=1+(p−1)/(N/4)
where p is a smoothing term, (i,j) is a term of an N×N matrix of an intra prediction residue block R_{N}, and (p−1)/(N/4) is a slope factor.

7. The method of claim 6, further comprising multiplying the slope factor by β, wherein β comprises a positive real number.

8. The method of claim 1, wherein the selectively applying of the secondary transform Tr_{K} to the residual data comprises:
determining a prediction mode; and
applying the secondary transform Tr_{K} in at least one of a horizontal direction and a vertical direction depending on the determined prediction mode.

9. The method of claim 8, wherein the primary transform C_{N} is applied to the residual data in the horizontal direction and the vertical direction, the secondary transform Tr_{K} is applied to the residual in the horizontal direction and the vertical direction, and the order of application of the primary transform C_{N} in the horizontal direction, the primary transform C_{N} in the vertical direction, the secondary transform Tr_{K} in the horizontal direction, and the secondary transform Tr_{K} in the vertical direction varies according to values of a block size and a transform size.

10. The method of claim 1, further comprising flipping the residual data prior to application of the primary transform C_{N} to the residual data.

11. An apparatus for encoding video data, the apparatus comprising:
a primary transform unit for determining a primary transform C_{N} for application to residual data and for applying the primary transform C_{N} to the residual data; and
a secondary transform unit for determining a secondary transform Tr_{K} for application to the residual data, and for selectively applying the secondary transform Tr_{K} to the residual data,
wherein N denotes the length size of the input vector on which the primary transform C_{N} is applied, and K denotes the length of the first few coefficients of the primary transform output on which the secondary transform Tr_{K} is applied.

12. The apparatus of claim 11, wherein the secondary transform unit determines the secondary transform Tr_{K} by determining a first correlation matrix R_{N} for length N input data, determining a second correlation matrix U_{N} for data obtained as a result of application of the primary transform C_{N}, determining a matrix V_{K,N} as the top K rows and K columns for the matrix U_{N}, determining the Karhunen-Loeve Transform (KLT) of V_{K,N} as W_{K,N}, and determining an integer based approximation of W_{K,N} as Y_{K,N} and using it as Tr_{K}.

13. The apparatus of claim 12, further wherein the secondary transform unit multiplies W_{K,N} by 2^{m}, and rounds the multiplication result to a nearest integer, wherein m is an integer >0 and denotes a required precision.

14. The apparatus of claim 12, wherein the secondary transform unit obtains the subset matrix by applying the following equation:
$${V}_{K , Avg} = {\sum }_{i} {p}_{i} {V}_{K , i , Normalized}$$
wherein pᵢ denotes a probability of input being i-point, i denotes a running index for the i-point input distribution with probability pᵢ, V_{K,i,Normalized}=(1/i) V_{K,i}=(1/i) Uᵢ (1:K,1:K), Uᵢ=Cᵢ^{T}*Rᵢ*Cᵢ; Rᵢ is the correlation for i-point input, and Cᵢ is the i×i primary transform.

15. The apparatus of claim 12, further wherein the secondary transform unit performs smoothing on the first correlation matrix R_{N}.

16. The apparatus of claim 15, wherein the secondary transform unit performs the smoothing of the first correlation matrix R_{N} by applying the following equation:
p=min(i,j)
R_{N}(i,j)=1+(p−1)/(N/4)
where p is a smoothing term, (i,j) is a term of an N×N matrix of an intra prediction residue block R_{N}, and (p−1)/(N/4) is a slope factor.

17. The apparatus of claim 16, further wherein the secondary transform unit multiplies the slope factor by β, wherein β comprises a positive real number.

18. The apparatus of claim 11, wherein the secondary transform unit selectively applies the secondary transform Tr_{K} to the residual data by determining a prediction mode, and applying the secondary transform Tr_{K} in at least one of a horizontal direction and a vertical direction depending on the determined prediction mode.

19. The apparatus of claim 18, wherein the primary transform C_{N} is applied to the residual data in the horizontal direction and the vertical direction, the secondary transform Tr_{K} is applied to the residual in the horizontal direction and the vertical direction, and the order of application of the primary transform C_{N} in the horizontal direction, the primary transform C_{N} in the vertical direction, the secondary transform Tr_{K} in the horizontal direction, and the secondary transform Tr_{K} in the vertical direction varies according to values of a block size and a transform size.

20. The apparatus of claim 11, further comprising at least one of a motion estimator and a motion compensator for flipping the residual data prior to application of the primary transform C_{N} to the residual data.

21. A method for decoding video data, the method comprising:
determining an inverse secondary transform inv(Tr_{K}), where inv( ) denotes the inverse operation, for application to residual data;
determining an inverse primary transform inv(C_{N}) for application to the residual data or an output of an inverse secondary transform unit;
selectively applying the inverse secondary transform inv(Tr_{K}) to the residual data; and
applying the inverse primary transform inv(C_{N}) to the residual data,
wherein N denotes the length size of the input vector on which the inverse primary transform inv(C_{N}) is applied, and K denotes the length of the first few coefficients of the residual data on which the inverse secondary transform inv(Tr_{K}) is applied.

22. The method of claim 21, wherein the determining of the inverse secondary transform inv(Tr_{K}) comprises:
determining a first correlation matrix R_{N} for length N input data at an encoder;
determining a second correlation matrix U_{N} for data obtained as a result of application of the primary transform C_{N} on input data during encoding;
determining a matrix V_{K,N} as the top K rows and K columns for the matrix U_{N;}
determining the Karhunen-Loeve Transform (KLT) of V_{K,N} as W_{K,N}; and
determining an integer based approximation of W_{K,N} as Y_{K,N} and using it as Tr_{K}.

23. The method of claim 22, further comprising:
multiplying W_{K,N} by 2^{m}; and
rounding the multiplication result to a nearest integer,
wherein m is an integer >0 and denotes a required precision.

24. The method of claim 22, wherein the obtaining of the subset matrix comprises application of the following equation:
$${V}_{K , Avg} = {\sum }_{i} {p}_{i} {V}_{K , i , Normalized}$$
wherein pᵢ denotes a probability of input being i-point, i denotes a running index for the i-point input distribution with probability pᵢ, V_{K,i,Normalized}=(1/i) V_{K,i}=(1/i) Uᵢ (1:K,1:K), Uᵢ=Cᵢ^{T}*Rᵢ*Cᵢ; Rᵢ is the correlation for i-point input, and Cᵢ is the i×i primary transform.

25. The method of claim 22, further comprising smoothing the first correlation matrix R_{N}.

26. The method of claim 25, wherein the smoothing of the first correlation matrix R_{N} comprises application of the following equation:
p=min(i,j)
R_{N}(i,j)=1+(p−1)/(N/4)
where p is a smoothing term, (i,j) is a term of an N×N matrix of an intra prediction residue block R_{N}, and (p−1)/(N/4) is a slope factor.

27. The method of claim 26, further comprising multiplying the slope factor by β, wherein β comprises a positive real number.

28. The method of claim 21, wherein the selectively applying of the inverse secondary transform inv(Tr_{K}) to the residual data comprises:
determining a prediction mode; and
applying the inverse secondary transform inv(Tr_{K}) in at least one of a horizontal direction and a vertical direction depending on the determined prediction mode.

29. The method of claim 28, wherein the inverse secondary transform inv(Tr_{K}) is applied to the residual data in the horizontal direction and the vertical direction, the inverse primary transform inv(C_{N}) is applied to the residual data in the horizontal direction and the vertical direction, and the order of application of the inverse secondary transform inv(Tr_{K}) in the horizontal direction, the inverse secondary transform inv(Tr_{K}) in the vertical direction, the inverse primary transform inv(C_{N}) in the horizontal direction, and the inverse primary transform inv(C_{N}) in the vertical direction varies according to values of a block size and a transform size.

30. The method of claim 21, further comprising flipping the residual data after the application of the inverse primary transform inv(C_{N}) to the residual data.

31. An apparatus for decoding video data, the apparatus comprising:
an inverse secondary transform unit for determining an inverse secondary transform inv(Tr_{K}) for application to residual data, and for selectively applying the inverse secondary transform inv(Tr_{K}) to the residual data; and
an inverse primary transform unit for determining an inverse primary transform inv(C_{N}) for application to the residual data or an output of the inverse secondary transform unit, and for applying the inverse primary transform inv(C_{N}) to the residual data or the output of the inverse secondary transform unit,
wherein K denotes the length of the first few coefficients of the residual data on which the inverse secondary transform inv(Tr_{K}) is applied, and N denotes the length size of the input vector on which the inverse primary transform inv(C_{N}) is applied

32. The apparatus of claim 31, wherein the inverse secondary transform unit determines the inverse secondary transform inv(Tr_{K}) by determining a first correlation matrix R_{N} for length N input data at an encoding unit, determining a second correlation matrix U_{N} for data obtained as a result of application of the primary transform C_{N} on input data during encoding, determining a matrix V_{K,N} as the top K rows and K columns for the matrix U_{N}, determining the Karhunen-Loeve Transform (KLT) of V_{K,N} as W_{K,N}, and determining an integer based approximation of W_{K,N} as Y_{K,N} and using it as Tr_{K}.

33. The apparatus of claim 32, further wherein the inverse secondary transform unit multiplies W_{K,N} by 2^{m}, and rounds the multiplication result to a nearest integer, wherein m is an integer >0 and denotes a required precision.

34. The apparatus of claim 32, wherein the inverse secondary transform unit obtains the subset matrix by applying the following equation:
$${V}_{K , Avg} = {\sum }_{i} {p}_{i} {V}_{K , i , Normalized}$$
wherein pᵢ denotes a probability of input being i-point, i denotes a running index for the i-point input distribution with probability pᵢ, V_{K,i,Normalized}=(1/i) V_{K,i}=(1/i) Uᵢ (1:K,1:K), Uᵢ=Cᵢ^{T}*Rᵢ*Cᵢ; Rᵢ is the correlation for i-point input, and Cᵢ is the i×i primary transform.

35. The apparatus of claim 32, further wherein the inverse secondary transform unit performs smoothing on the first correlation matrix R_{N}.

36. The apparatus of claim 35, wherein the inverse secondary transform unit performs the smoothing of the correlation matrix by applying the following equation:
p=min(i,j)
R_{N}(i,j)=1+(p−1)/(N/4)
where p is a smoothing term, (i,j) is a term of an N×N matrix of an intra prediction residue block R_{N}, and (p−1)/(N/4) is a slope factor.

37. The apparatus of claim 36, further wherein the inverse secondary transform unit multiplies the slope factor by β, wherein β comprises a positive real number.

38. The apparatus of claim 31, wherein the inverse secondary transform unit selectively applies the inverse secondary transform inv(Tr_{K}) to the residual data by determining a prediction mode, and applying the inverse secondary transform inv(Tr_{K}) in at least one of a horizontal direction and a vertical direction depending on the determined prediction mode.

39. The apparatus of claim 38, wherein the inverse secondary transform inv(Tr_{K}) is applied to the residual data in the horizontal direction and the vertical direction, and then the inverse primary transform inv(C_{N}) is applied to the residual data or the output of the inverse secondary transform unit in the horizontal direction and the vertical direction, and the order of application of the inverse secondary transform inv(Tr_{K}) in the horizontal direction, the inverse secondary transform inv(Tr_{K}) in the vertical direction, the inverse primary transform inv(C_{N}) in the horizontal direction, and the inverse primary transform inv(C_{N}) in the vertical direction varies according to values of a block size and a transform size.

40. The apparatus of claim 31, further comprising at least one of a motion estimator and a motion compensator for flipping the residual data after the application of the inverse primary transform inv(C_{N}) to the residual data.
